(19) United States
(12) Patent Application Publication
(10) Pub. No.: US 2026/0320686 A1
(43) Pub. Date: Oct. 15, 2026

(54) SYSTEM AND METHOD FOR BACKTESTING GAMIFICATION

(71) Applicant: FX Replay, Inc., Oklahoma City, OK (US)

(72) Inventors: Rodrigo A. Collao Benitez, Norman, OK (US); Matthew Concordia, Innisfil (CA)

(21) Appl. No.: 19/645,933

(22) Filed: Apr. 13, 2026

Related U.S. Application Data
(60) Provisional application No. 63/787,539, filed on Apr. 11, 2025.

(51) Int. Cl. G06Q 40/04; A63F 9/00; A63F 11/00

(52) U.S. Cl. CPC G06Q 40/042; A63F 9/0076; A63F 11/0074

(57) ABSTRACT

A gamified backtesting system comprises a device having a memory and a processor that: receives a request to create a match from an administrator; receives a first and second join signal from a first and second participant user devices having respective IDs and associates the respective IDs with a match ID; receives a start signal from the administrator; generates a first backtesting session for the first participant and a second backtesting session for the second participant based on the match properties; simultaneously manages execution of and tracks performance metrics for the first backtesting session and the second backtesting session; determines whether any match termination criteria have been met; on termination criteria being met, terminates the first backtesting session and the second backtesting session simultaneously; determines a match winner; and transmits a match end signal to the first and second user devices to cause the same to indicate the match winner.

### CROSS-REFERENCE TO RELATED APPLICATIONS

The present application claims priority to Provisional Patent Application U.S. Ser. No. 63/787,539 titled “System and Method for Backtesting Gamification” filed on Apr. 11, 2025, the entire content of which is hereby expressly incorporated herein by reference in its entirety.

### BACKGROUND

In the context of financial market analysis and strategy development, backtesting plays a crucial role in assessing the effectiveness and robustness of trading strategies. By simulating the application of a particular trading strategy on historical securities data, analysts and investors can gain valuable insights into how the particular trading strategy would have performed under various market conditions. However, traditional backtesting methodologies often overlook the significance of economic events and their impact on market dynamics.

The substantial data requirements for comprehensive backtesting pose significant challenges to system performance and efficiency. Traditional backtesting methodologies often require processing of vast amounts of historical financial data, including price movements, trading volumes, and various market indicators across multiple securities and timeframes. As the complexity of trading strategies increases and the desire for more granular analysis grows, the volume of data required for accurate backtesting expands exponentially. This data deluge can overwhelm conventional computing systems, leading to extended processing times and reduced operational efficiency. This latency results in a user experience characterized by noticeable lag for the user and a failure to accurately simulate real-time trading.

In traditional backtesting architectures, the transmission of price data between a server storing historical market data and a user device presents a significant bottleneck. When a user requests historical data for a backtesting session, conventional systems typically either transmit the entire dataset upfront (resulting in long initial load times and excessive memory consumption on the user device) or repeatedly query the server as the simulation progresses (creating network congestion and server load that scales poorly as the simulation advances). Both approaches suffer from inefficiencies that degrade system responsiveness, especially when multiple clients are connected and accessing the data simultaneously. The resulting delays in data availability directly undermine the efficiency of the backtesting simulation, as the system cannot faithfully replicate the immediacy and fluidity of actual market trading conditions where price information and order execution occur with minimal latency.

The performance bottleneck in backtesting systems is further exacerbated by the need for real-time or near-real-time analysis in modern trading environments. As financial markets become increasingly dynamic and interconnected, the ability to rapidly backtest and adjust strategies in response to changing market conditions becomes crucial. However, the sheer volume of data involved in comprehensive backtesting often conflicts with this need for speed. The calculations required to simulate complex trading strategies across extensive historical datasets can result in latency issues that may render the backtesting results less actionable in fast-moving markets. When the backtesting interface exhibits noticeable lag during simulation progression in a multi-user session (such as when a user advances the simulation time forward), this lag creates an artificial delay that does not exist in real market trading, thereby reducing the fidelity of the simulation as a training and strategy evaluation tool. A trader practicing decision-making in a sluggish backtesting environment may develop timing habits and expectations that do not translate to actual market conditions where orders must be placed rapidly and market data updates continuously.

Furthermore, traditional backtesting systems are typically designed for individual use, limiting collaborative learning and competitive skill development. Financial traders and analysts often work in isolation when developing and testing strategies, missing valuable opportunities for knowledge sharing, skill benchmarking, and competitive improvement. The absence of structured competitive environments within backtesting platforms prevents users from comparing their trading strategies against peers in standardized conditions, which is a significant limitation given that financial markets are inherently competitive environments.

Current backtesting solutions generally lack mechanisms for organizing multi-participant trading competitions or tournaments that could simulate real-world competitive trading scenarios. Without such capabilities, users cannot easily participate in structured trading challenges that might accelerate skill development through direct competition. Additionally, the administration of trading competitions, when attempted manually, is cumbersome and lacks standardization across participants.

Moreover, existing systems typically do not provide tournament management functionality that would allow for the creation of multi-round competitions with consistent rules, controlled asset selection, and performance tracking across numerous participants. This limitation prevents effectively using backtesting as a competitive learning tool.

Therefore, a need exists for an improved backtesting system that addresses these limitations, including both the technical performance constraints and the collaborative/competitive functionality gaps.

### SUMMARY

To address these limitations, including accurate simulation of a trading strategy on historic market instruments, there is a growing need for a backtesting solution that processes historical data to reduce latency on the user device and enables collaborative and competitive trading scenarios through structured tournament environments.

The system and method described herein provide a technical solution to the problem of accurately simulating historical market data in a backtesting session. Specifically, the backtesting system utilizes a dual-buffer arrangement between a user device and a service device that communicate using an event-based communication session. These solutions improve the accuracy and realism of the backtesting simulation. Additionally, the system provides tournament management capabilities that facilitate the creation and administration of multi-participant trading competitions with standardized rules and conditions.

Furthermore, the backtesting system employs a novel approach to efficiently manage and display large amounts of economic event data. Rather than repeatedly querying the backtesting system for updated historical data as the simulation time advances, the user device retrieves a delta-encoded buffer of price data from a service buffer of price data maintained by the service device. In this way, network traffic requirements and backtesting system computational load can be reduced, while enabling responsive updates to the primary user interface of the user device. The system further incorporates tournament administration interfaces that allow for the creation, management, and tracking of competitive backtesting matches, enabling users to participate in structured trading competitions with standardized parameters. The result is a more efficient and performant backtesting system that can handle complex simulations with complex and numerous historical financial instruments while facilitating collaborative learning and competitive skill development through multi-participant tournaments.

The problem of accurately simulating historical market data in the backtesting session and providing structured competitive environments for multiple participants, is solved by the systems and methods herein disclosed. The systems and methods include a backtesting system, comprising a service device, comprising: a service processor; and a service memory. The service memory comprises a non-transitory processor-readable medium storing processor-executable instructions that when executed by the service processor, causes the service processor to: receive a request to create a match having match properties from an administrator device of a tournament administrator, the match properties comprising at least a match name, a match time limit, a max participants value, a match starting balance, and a session pair list; store the match properties in the service memory; receive a first join match signal from a first user device of a first potential participant having a first user ID; associate the first user ID with a match ID of the match such that the first potential participant is a first participant; receive a second join match signal from a second user device of a second potential participant having a second user ID; associate the second user ID with the match ID such that the second potential participant is a second participant; receive a start match signal from the administrator device of the tournament administrator; generate a first backtesting session for the first participant based on the match properties and a second backtesting session for the second participant based on the match properties; simultaneously manage execution of and track performance metrics for the first backtesting session and the second backtesting session; determine whether any match termination criteria have been met, the match termination criteria comprising at least expiration of the match time limit; upon determining at least one match termination criteria has been met, terminate the first backtesting session and the second backtesting session simultaneously; determine a match winner between the first participant and the second participant based on at least one performance metric; and transmit a match end signal to the first user device and the second user device to cause the first user device and the second user device to display a match end modal indicating the match winner.

The problem of accurately simulating historical market data in the backtesting session and providing structured competitive environments for multiple participants, is further solved by a method for providing a backtesting tournament, the method comprising: receiving, by a service device, a request to create a match having match properties from a tournament administrator; storing, by the service device, the match properties in a service memory, the match properties comprising at least a match name, a match time limit, a max participants value, a match starting balance, and a session pair list; receiving, by the service device, a first join match signal from a first user device of a first potential participant having a first user ID; associating, by the service device, the first user ID with a match ID of the match such that the first potential participant is a first participant; receiving, by the service device, a second join match signal from a second user device of a second potential participant having a second user ID; associating, by the service device, the second user ID with the match ID such that the second potential participant is a second participant; receiving, by the service device, a start match signal from an administrator device of the tournament administrator; generating, by the service device, a first backtesting session for the first participant based on the match properties and a second backtesting session for the second participant based on the match properties; simultaneously managing, by the service device, execution of and tracking performance metrics for the first backtesting session and the second backtesting session; determining, by the service device, whether any match termination criteria have been met, the match termination criteria comprising at least expiration of the match time limit; upon determining at least one match termination criteria has been met, terminating, by the service device, the first backtesting session and the second backtesting session simultaneously; determining, by the service device, a match winner between the first participant and the second participant based on at least one performance metric; and transmitting, by the service device, a match end signal to the first user device and the second user device to cause the first user device and the second user device to display a match end modal indicating the match winner.

The foregoing Summary provides an overview of certain selected implementations or embodiments disclosed herein, and is not intended to describe every aspect, embodiment, implementation, feature, or advantage of the disclosure exhaustively or comprehensively. Therefore, this Summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

Implementations of the above techniques include methods, apparatus, systems, and computer program products are herein described. One such computer program product is suitably embodied in a non-transitory computer-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

### BRIEF DESCRIPTION OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary embodiment of hardware forming a system constructed in accordance with the present disclosure;

FIG. 2 is a diagram of an exemplary embodiment of a user device for use in the system of FIG. 1 constructed in accordance with the present disclosure;

FIG. 3 is a diagram of an exemplary embodiment of a service device of the system of FIG. 1 constructed in accordance with the present disclosure;

FIG. 4 is a screenshot of an exemplary embodiment of a primary user interface displaying a backtesting session view at a first simulation time and constructed in accordance with the present disclosure;

FIG. 5 is a diagram of an exemplary embodiment of a session-service socket connection process constructed in accordance with the present disclosure;

FIG. 6A is a first diagram of an exemplary embodiment of a session-service update process constructed in accordance with the present disclosure;

FIG. 6B is a second diagram of an exemplary embodiment of the session-service update process of FIG. 6A constructed in accordance with the present disclosure;

FIG. 7A is an illustration of an exemplary embodiment of the user device displaying the primary user interface with a match dashboard constructed in accordance with the present disclosure;

FIG. 7B is an illustration of an exemplary embodiment of a match card constructed in accordance with the present disclosure;

FIG. 8A is an illustration of an exemplary embodiment of the user device displaying the primary user interface with the match dashboard showing the new tournament modal having a first new tournament form constructed in accordance with the present disclosure;

FIG. 8B is an illustration of an exemplary embodiment of the user device displaying the primary user interface with the match dashboard showing the new tournament modal having a second new tournament form constructed in accordance with the present disclosure;

FIG. 8C is an illustration of an exemplary embodiment of the user device displaying the primary user interface with the match dashboard showing the new tournament modal having a third new tournament form constructed in accordance with the present disclosure;

FIG. 9A is an illustration of an exemplary embodiment of the user device displaying the primary user interface with the tournament administration view constructed in accordance with the present disclosure;

FIG. 9B is an illustration of an exemplary embodiment of a first new match form of the new match modal constructed in accordance with the present disclosure;

FIG. 9C is an illustration of an exemplary embodiment of a second new match form of the new match modal constructed in accordance with the present disclosure;

FIG. 9D is an illustration of an exemplary embodiment of the tournament administration view including the new match drawn in accordance with the present disclosure;

FIG. 9E is an illustration of an exemplary embodiment of a match controller in a first state constructed in accordance with the present disclosure;

FIG. 9F is an illustration of an exemplary embodiment of a match controller in a second state constructed in accordance with the present disclosure;

FIG. 10 is an illustration of an exemplary embodiment of the user device displaying the primary user interface with the tournament administration view showing a global leaderboard as constructed in accordance with the present disclosure;

FIGS. 11A-11B in combination are a flow diagram of an exemplary embodiment of a challenge process constructed in accordance with the present disclosure;

FIGS. 12A-12B in combination are a flow chart of an exemplary embodiment of a create challenge flow constructed in accordance with the present disclosure;

FIG. 13 is a process flow diagram of an exemplary embodiment of a match process constructed in accordance with the present disclosure;

FIG. 14 is a process flow diagram of an exemplary embodiment of a challenge creation process constructed in accordance with the present disclosure; and

FIG. 15 is a process flow diagram of an exemplary embodiment of a participant flow constructed in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the disclosure as described herein. Where a range of numerical values is stated herein as being less than a stated value, the range is nevertheless bounded on its lower end by a non-zero value. It is not intended that the scope of the disclosure be limited to the specific values recited when defining a range. All ranges are inclusive and combinable.

Circuitry, as used herein, may be analog and/or digital components, or one or more suitably programmed processors (e.g., microprocessors) and associated hardware and software, or hardwired logic. Also, “components” may perform one or more functions. The term “processing component,” may include hardware, such as a processor (e.g., microprocessor), an application specific integrated circuit (ASIC), a field programmable gate array (FPGA), a combination of hardware and software, software, and/or the like. The term “processor” as used herein means a single processor or multiple processors working independently or together to collectively perform a task.

Software may include one or more computer readable instruction that when executed by one or more component, e.g., a processor, causes the component to perform a specified function. It should be understood that the algorithms described herein may be stored on one or more non-transitory computer-readable medium. Exemplary non-transitory computer-readable media may include a non-volatile memory, a volatile memory, a random-access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, phase change memory, combinations thereof, and/or the like. Such non-transitory computer-readable media may be electrically based, optically based, magnetically based, material-phase based, resistive based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

As used herein, the terms “modal”, “view”, “pane”, or “screen” and any variation thereof are intended to include particular groupings of user interface (UI) elements as used in user experience (UX) or UI design. For example, a modal, view, or screen may be any of a slide-in panel, a sidebar, a popover, an accordion, a drawer, a banner, a multi-step form, a full-page overlay, a partial-page overlay, a sticky element, a tab, a dialog box, an embedded iframe/widget, floating actions, a carousel/slider, expanding/collapsible section, tooltips/hover cards, and/or the like, or a combination thereof.

As used herein, the term “financial instrument” (also referred to herein as a “historic market instrument”) refers to a tradable asset or security that can be bought, sold, or exchanged in financial markets. Financial instruments may include, but are not limited to, equities such as stocks and shares in publicly traded companies, fixed-income securities such as bonds and treasury notes, currencies and foreign exchange pairs (e.g., United States Dollar (USD), Euro (EUR), British Pound (GBP), and/or the like), commodities such as precious metals (e.g., gold, silver, platinum), energy resources (e.g., crude oil, natural gas), and agricultural products (e.g., wheat, corn, soybeans), derivatives such as futures contracts and options, exchange-traded funds (ETFs), indices, cryptocurrency assets, and any other tradable asset or security available through financial markets. The term encompasses both individual instruments and pairs of instruments (e.g., currency pairs such as EUR/USD), where the relative value or exchange rate between two financial instruments forms the basis for trading analysis. Throughout this disclosure, the terms “financial instrument” and “historic market instrument” are used interchangeably and should be understood to have the same meaning, with “historic” referring to the fact that the financial instrument data being analyzed pertains to past market activity rather than real-time trading.

As used herein, the term “backtesting” refers to a method used by investors, traders, and/or financial analysts to evaluate the potential performance of a trading strategy or investment model using historical data for one or more financial instruments. During backtesting, the trading strategy is applied to the historical data to ascertain how the trading strategy would have performed had it been implemented during a specified historical period of time. Backtesting involves simulating the historical data of the financial instrument as though the financial instrument was presently being traded, such as in the stock market. The user is provided with an ability to make simulated trades (e.g., opening and closing positions and placing orders such as limit and stop orders) against the historical data of the financial instrument in a simulation time (optionally, corresponding to the historical period of time for a market that has already closed). The user is further provided with an ability to analyze backtesting results to identify potential trends, risks, returns, and/or other performance metrics associated with the trading strategy. Thus, backtesting serves as a tool for refining trading strategies and for identifying potential strengths and weaknesses of those trading strategies before implementing the trading strategies in real-time trading. The historical data may include granular price data for the financial instrument, where each price datum includes at least a timestamp (indicating when a particular market transaction or price observation occurred) and a market value (indicating the price of the financial instrument at that timestamp).

Referring now to the drawings, and in particular to FIG. 1, shown therein is a diagram of an exemplary embodiment of a backtesting system 10 constructed in accordance with the present disclosure. A plurality of users 14 (individually, user 14) may interact, i.e., via two way-communications, with the backtesting system 10 using a respective user device 18 that may be used to interact with a service device 22. Each user device 18 may communicate with the service device 22 via a network 26. In one embodiment, each user 14 may have a user profile associated with user settings that allows the particular user 14 to access the service device 22 via the particular user device 18 on which the particular user 14 is signed in. As shown in FIG. 1, a first user 14a may interact with a first user device 18a to access the service device 22 and a second user 14b may interact with a second user device 18b to access the service device 22. In one embodiment, the first user 14a and the second user 14b may be the same user 14 and the first user device 18a and the second user device 18b may be the same user device 18, such that the same user 14 utilizes the same user device 18 to provide a first primary user interface 30a associated with a first backtesting session instance and a second primary user interface 30b associated with a second backtesting session instance. The first backtesting session instance and the second backtesting session instance may be different instances of the same backtesting session or, in some embodiments, may be instances of different backtesting sessions. Each backtesting session instance may have both a backtesting instance ID identifying a particular backtesting instance and a backtesting session ID identifying a particular backtesting session.

In another embodiment, the first user 14a and the second user 14b may be the same user 14 and the first user device 18a and the second user device 18b may be different user devices 18, such that the same user 14 utilizes the first user device 18a to provide a first primary user interface 30a associated with a first backtesting session instance and utilizes the second user device 18b to provide a second primary user interface 30b associated with a second backtesting session instance. The first backtesting session instance and the second backtesting session instance may be instances of the same backtesting session or, in some embodiments, may be instances of different backtesting sessions. Each backtesting session instance may have both a backtesting instance ID identifying a particular backtesting instance and a backtesting session ID identifying a particular backtesting session.

In some embodiments, the network 26 may be the Internet and/or other network. For example, if the network 26 is the Internet, a primary user interface 30 (described below in more detail) of the backtesting system 10 may be delivered through a series of web pages or private internal web pages of a company or corporation, which may be written in hypertext markup language (HTML/PHP/JavaScript), for example, and may be accessible by the user device 18. It should be noted that the primary user interface 30 of the backtesting system 10 may be another type of interface including, but not limited to, a Windows-based application, a server-based application, a tablet-based application, a mobile web interface, an application running on a mobile device, a virtual-reality interface, an augmented-reality interface, and/or the like.

The network 26 may be almost any type of network. For example, in some embodiments, the network 26 may be a version of an Internet network (e.g., exist in a UPD or TCP/IP-based network). In one embodiment, the network 26 is the Internet. It should be noted, however, that the network 26 may be almost any type of network and may be implemented as the World Wide Web (or Internet), a local area network (LAN), a wide area network (WAN), an LPWAN, a LoRa network, a metropolitan network, a wireless network, a WIFI network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, a short-wave wireless network, a long-wave wireless network, combinations thereof, and/or the like. It is conceivable that in the near future, embodiments of the present disclosure may use more advanced networking topologies.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of backtesting system 10 may perform one or more functions described as being performed by another one or more of the devices of the backtesting system 10. Devices of the backtesting system 10 may interconnect via wired connections, wireless connections, or a combination thereof.

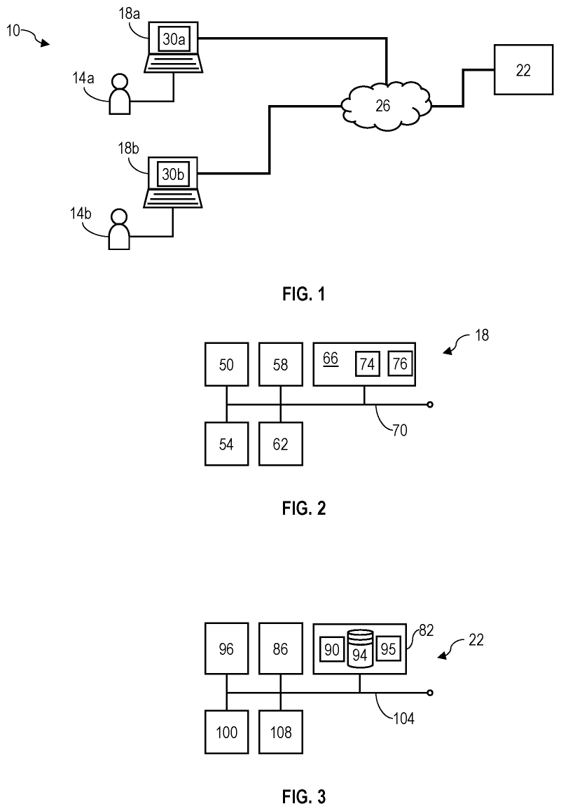

Referring now to FIG. 2, shown therein is a diagram of an exemplary embodiment of the user device 18 of the backtesting system 10 constructed in accordance with the present disclosure. In some embodiments, the user device 18 may include, but is not limited to, implementations as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like. Each user device 18 of the backtesting system 10, e.g., the first user device 18a and the second user device 18b, may be constructed in accordance with the user device 18 as described herein.

In some embodiments, the user device 18 may include one or more input device 50 (hereinafter “input device 50”), one or more output device 54 (hereinafter “output device 54”), one or more client processor 58 (hereinafter “client processor 58”), one or more communication device 62 (hereinafter “communication device 62”) capable of interfacing with the network 26, one or more client memory 66 (hereinafter “client memory 66”) storing processor-executable code and/or user application(s) 74 (hereinafter “user application 74”). The user application 74 may include, for example, a web browser capable of accessing a website and/or communicating information and/or data over a wireless or wired network (e.g., the network 26), and/or the like. The input device 50, output device 54, client processor 58, communication device 62, and client memory 66 may be connected via a path 70 such as a data bus that permits communication among the components of user device 18.

The client processor 58 may be implemented as a single processor or multiple processors working together, or independently, to execute the user application 74 as described herein. It is to be understood, that in certain embodiments using more than one client processor 58, the client processors 58 may be located remotely from one another, located in the same location, or comprising a unitary multi-core processor. The client processors 58 may be capable of reading and/or executing processor-executable code and/or capable of creating, manipulating, retrieving, altering, and/or storing data structures into the client memory 66.

Exemplary embodiments of the client processor 58 may include, but are not limited to, a digital signal processor (DSP), a central processing unit (CPU), a field programmable gate array (FPGA), a graphics processing unit (GPU), a neural processing unit (NPU), a microprocessor, a multi-core processor, an application specific integrated circuit (ASIC), combinations thereof, and/or the like, for example. The client processor 58 may be capable of communicating with the client memory 66 via the path 70 (e.g., data bus). The client processor 58 may be capable of communicating with the input device 50 and/or the output device 54. The client processor 58 may include one or more client processor 58 working together, or independently, and located locally, or remotely, e.g., accessible via the network 26.

The client memory 66 may be one or more non-transitory processor-readable medium. The client memory 66 may store the user application 74 that, when executed by the client processor 58, causes the user device 18 to perform an action such as communicate with or control one or more component of the user device 18 and/or, via the network 26, the service device 22. The client memory 66 may be one or more client memory 66 working together, or independently, to store processor-executable code and may be located locally or remotely, e.g., accessible via the network 26. In one embodiment, the client memory 66 may further comprise a client buffer 76 of price data as described in more detail below.

The input device 50 may be capable of receiving information input from the user 14 and/or client processor 58, and transmitting such information to other components of the user device 18 and/or the network 26. The input device 50 may include, but is not limited to, implementation as a keyboard, a touchscreen, a mouse, a trackball, a microphone, a camera, a fingerprint reader, an infrared port, an optical port, a cell phone, a smart phone, a PDA, a remote control, a fax machine, a wearable communication device, a network interface, combinations thereof, and/or the like, for example. The input device 50 may include the primary user interface 30 on the user device 18.

The output device 54 may be capable of outputting information in a form perceivable by the user 14 and/or client processor 58. Implementations of the output device 54 may include, but are not limited to, a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and the like, for example. The output device 54 may display the primary user interface 30 on the user device 18.

It is to be understood that in some exemplary embodiments, the input device 50 and the output device 54 may be implemented as a single device, such as, for example, a touchscreen of a computer, a tablet, or a smartphone. It is to be further understood that as used herein the term user (e.g., the user 14) is not limited to a human being, and may comprise a computer, a server, a website, a processor, a network interface, a user terminal, a virtual computer, combinations thereof, and/or the like, for example.

The communication device 62, in communication with the client processor 58, may interface with the network 26. The network 26 may permit bi-directional communication of information and/or data between the user device 18 and/or the service device 22. The network 26 may interface with the service device 22 and/or the user device 18 in a variety of ways. For example, in some embodiments, the network 26 may interface by optical and/or electronic interfaces, and/or may use a plurality of network topographies and/or protocols including, but not limited to, Ethernet, UDP/TCP/IP, circuit switched path, combinations thereof, and/or the like, as described above. For example, the client processor 58 may be capable of communicating via the network 26 by exchanging signals (e.g., analog, digital, optical, and/or the like) via one or more port (e.g., physical or virtual ports) using a network protocol to provide updated information to the service device 22 (e.g., to a backtesting application 90 (described below) executed on the service device 22).

Referring now to FIG. 3, shown therein is a diagram of an exemplary embodiment of the service device 22 constructed in accordance with the present disclosure. The service device 22 may include one or more device that execute(s) one or more application or service in a manner described herein. In the illustrated embodiment, the service device 22 is provided with a service memory 82 (hereinafter “service memory 82”) accessible by one or more service processor 86 (hereinafter “service processor 86”). The service memory 82 may include one or more non-transitory processor-readable medium storing processor-executable code and/or software application(s) 90 (hereinafter “backtesting application 90”) and one or more database 94 (hereinafter “database 94”).

The service memory 82 may further store, for example, the historical data for a plurality of market instruments. In some embodiments, the historical data may be stored, for example, in the database 94. In one embodiment, the service memory 82 may further comprise a service buffer 95 of price data (e.g., a cache). In some embodiments, the service memory 82 may store the service buffer 95 for each backtesting session being executed by users 14 on the service device 22. For example, the first user 14a may use the first user device 18a to execute a first backtesting session and connect to the service device 22 causing the service device 22 to generate a first service buffer for the first backtesting session and the second user 14b may use the second user device 18b to execute a second backtesting session and connect to the service device 22 causing the service device 22 to generate a second service buffer for the second backtesting session. In some embodiments, the service buffer 95 may be stored in an in-memory datastore/database. Exemplary in-memory datastores may include, for example, REDIS® (Redis Ltd., San Francisco, CA, USA).

In some embodiments, the service device 22 may comprise the one or more service processor 86 working together, or independently to, execute processor-executable code, such as the backtesting application 90, stored on the service memory 82. Additionally, the service device 22 may include at least one input device 96 (hereinafter “input device 96”) and at least one output device 100 (hereinafter “output device 100”). Each element of the service device 22 may be partially or completely network-based or cloud-based, and may or may not be located in a single physical location.

The service processor 86 may be implemented as a single processor or multiple processors working together, or independently, to execute the backtesting application 90 as described herein. It is to be understood, that in certain embodiments using more than one service processor 86, the service processor 86 may be located remotely from one another, located in the same location, or comprising a unitary multi-core processor. The service processor 86 may be capable of reading and/or executing processor-executable code and/or capable of creating, manipulating, retrieving, altering, and/or storing data structures into the service memory 82 such as in the database 94.

Exemplary embodiments of the service processor 86 may be constructed similar to and in accordance with the client processor 58 described above in more detail. The service processor 86 may be capable of communicating with the service memory 82 via a path 104 (e.g., data bus). The service processor 86 may be capable of communicating with the input device 96 and/or the output device 100.

The service processor 86 may be further capable of interfacing and/or communicating with the user device 18 via the network 26 using a communication device 108. For example, the service processor 86 may be capable of communicating via the network 26 by exchanging signals (e.g., analog, digital, optical, and/or the like) via one or more port (e.g., physical or virtual ports) using a network protocol to provide updated information to the user application 74 or the primary user interface 30 executed on the user device 18.

In some embodiments, the service memory 82 may be located in the same physical location as the service device 22, and/or one or more service memory 82 may be located remotely from the service device 22. For example, the service memory 82 may be located remotely from the service device 22 and communicate with the service processor 86 via the network 26. Additionally, when more than one service memory 82 is used, a first service memory 82 may be located in the same physical location as the service processor 86, and additional service memory 82 may be located in a location physically remote from the service processor 86. Additionally, the service memory 82 may be implemented as a “cloud” non-transitory processor-readable medium (i.e., one or more service memory 82 may be partially or completely based on or accessed using the network 26).

The service memory 82 may store processor-executable code and/or information comprising the database 94 and the backtesting application 90. In some embodiments, the backtesting application 90 may be stored as a compiled application file, such as an executable file, for example, or in a structure (or unstructured) format, such as, e.g., in a non-compiled file. The backtesting application 90 may include one or more module of processor-executable code. For example, the backtesting application 90 may include a session module 90a and an order module 90b, as described below.

In one embodiment, the database 94 can be a relational database, a time-series database, a vector database, a non-relational database, a document database, and/or the like, or combinations thereof. Examples of such databases comprise, DB2®, Microsoft® Access, Microsoft® SQL Server, Oracle®, MySQL, PostgreSQL, MongoDB, Apache Cassandra, Weaviate, REDIS®, and the like. It should be understood that these examples have been provided for the purposes of illustration only and should not be construed as limiting the presently disclosed inventive concepts. The database 94 can be centralized or distributed across multiple systems. For example, the database 94 may include a first database 94a storing user data and/or backtesting session data (described below) and a second database 94b storing the historical data, e.g., as a historical data database.

The input device 96 of the service device 22 may transmit data to the service processor 86 and may be constructed in accordance with or similar to the input device 50 of the user device 18 described above in more detail. The input device 96 may be located in the same physical location as the service processor 86, or located remotely and/or partially or completely network-based. The output device 100 of the service device 22 may transmit information from the service processor 86 to the user 14, and may be similar to the output device 54 of the user device 18. The output device 100 may be located with the service processor 86, or located remotely and/or partially or completely network-based.

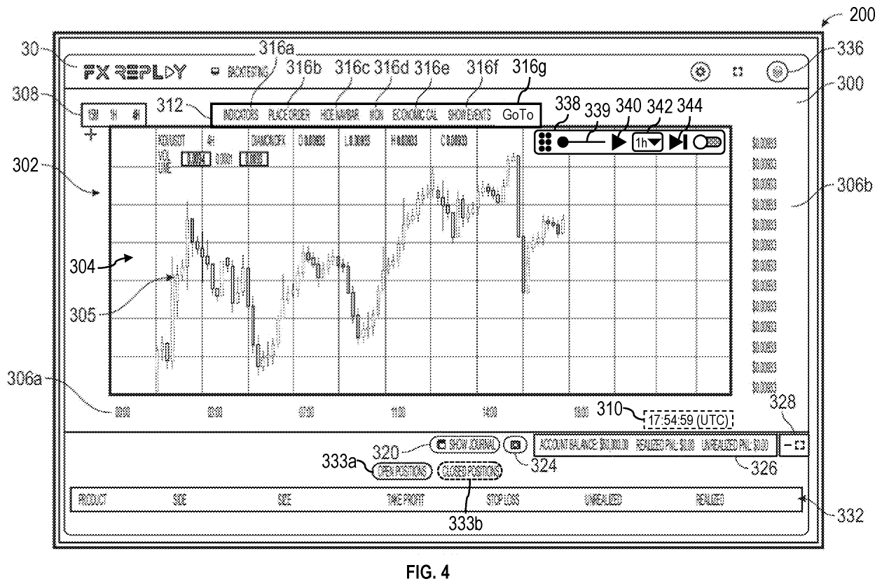

Referring now to FIG. 4, shown therein is a screenshot 200 of an exemplary embodiment of the user device 18 displaying the primary user interface 30 with a backtesting session view 300 displayed in accordance with the present disclosure. Generally, the backtesting session view 300 displays information of a backtesting session having session data, such as the backtesting session associated with a particular challenge. As shown by the screenshot 200, the client processor 58 may display the primary user interface 30 of the backtesting application 90 on the user device 18.

In one embodiment, backtesting sessions having session data may be stored in the service memory 82, such as in the database 94. The service processor 86 may transmit selected ones of the backtesting session to respective the user devices 18, such as by transmitting session data associated with a particular user ID to the user device 18 associated with that particular user ID. The client processor 58 of the user device 18 may receive the transmitted backtesting session and may store the session data in the client memory 66 and/or may display at least part of the session data on the output device 54.

In one embodiment, each backtesting session may include one or more backtesting properties included in the session data, such as: a simulation timeframe corresponding to a historic timeframe over which the backtesting session is executed and corresponds to a historic data/time of the historic market instrument; a simulation duration corresponding to a time period between a beginning time and an ending time of the simulation timeframe, a session name; a starting balance; a strategy name corresponding to a name of a strategy; a session pair corresponding to any financial instrument or asset available within the backtesting session and corresponding to the historic market instrument being examined as part of the backtesting session. For example, the session pair of instruments may encompass two or more assets, such as one or more financial instruments. The one or more financial instruments may include, for example, stocks, bonds, currency (e.g., United States Dollar (USD), Euro (EUR), and the like), cryptocurrency (e.g., Bitcoin (BTC) and the like), commodities (e.g., gold and silver) and/or any other tradable asset. While shown as currency session pairs associated with currency in the accompanying drawings, the session pairs are not limited to currency session pairs alone and may encompass a wide range of assets or financial instruments that the user desires to analyze.

In one embodiment, the backtesting session view 300 may be generated by the service processor 86 and may be transmitted by the service processor 86 to the client processor 58 via the network 26. For example, the backtesting session view 300 may be a series of web pages or a web application that is generated by the service processor 86 and displayed on the primary user interface 30 on the output device 54 of the user device 18 by the client processor 58, such as by rendering a webpage of the primary user interface 30 using a predetermined computer language, e.g., hypertext markup language (HTML/PHP/JavaScript), for example. The backtesting session view 300 may be rendered by a call to any of a number of protocols, such as “HTTP”, “HTTPS”, “FTP”, and the like.

In one embodiment, each of the one or more backtesting properties are included in the backtesting session data and correspond to backtesting property labels for the associated backtesting session stored in the service memory 82, such as in the database 94, and may be associated with the particular backtesting session and the particular user 14, such as by linking a user ID and a backtesting session ID. The one or more backtesting properties in the backtesting session data may further include, for example, the backtesting session ID, a calculate fees option (set by the user 14), historic market instrument data (e.g., the historical data for the historic market instrument or financial instrument), an association to the user 14, a simulation timeframe, a current session time, and/or the like, for example. The backtesting session data for the backtesting session may further include a session manager (e.g., an identifier of a particular backtesting session instance such as the backtesting instance ID). In some embodiments, the backtesting session data further includes a connected instances property identifying each backtesting session instance connected to, and interacting with, the backtesting session.

By identifying the session manager, the backtesting session may support multiplayer backtesting sessions such that all players (e.g., users 14) may have a synchronized simulation time 310 (with the simulation time 310 of the session manager being the controlling simulation time, or in some embodiments, a current session time provided by the service device 22). Further, orders and positions for each user 14 may be executed independently of the orders/positions of other users 14. In some embodiments, the primary user interface 30 does not display orders / positions of other users 14; however, in other embodiments, the primary user interface 30 may display an indicator of orders/positions of other users 14. The indicator may be, for example, provided as an icon within the chart 302 on the primary user interface 30, the icon only indicating that an order/position has been taken by another user 14. In other embodiments, the indicator may be, for example, an indicator showing properties of the order/position the other user 14 has taken.

In one embodiment, the session manager may be controlled by a tournament manager, as described below in more detail. The tournament manager may control one or more backtesting session such that the particular backtesting session may only be executed by the particular user when approved to execute by the tournament manager. The tournament manager may provide a predetermined pair list of session pairs from which the user 14 may select as part of the user's associated backtesting session. The tournament manager may further set/provide the backtesting timeframe, simulation time, and/or simulation duration.

As shown, the backtesting session view 300 includes a chart 302 having a graph 304, such as a candlestick line graph, showing a value of a historic market instrument 305 (e.g., historical data for a stock, financial market, or foreign exchange market that is at least one market-day old, or from a prior market-day) and having an axis of abscissas 306a showing time values within a chart timeframe, and an axis of ordinates 306b showing an instrument value. The backtesting session view 300 provides the user with a time granularity input 308 for selecting a time granularity. The time granularity determines a ticker timeframe represented by each ticker step of the graph 304, where the ticker timeframe is the period of time for which each candlestick of the graph 304 of the historic market instrument 305 pertains.

While the time granularity input 308 is shown as having values of 15 min, 1 hour, and 4 hours, it should be understood that other time granularities of the ticker step may be selectable by the user, for example, the time granularity input 308 may have options including, but not limited to, 1 second, 5 seconds, 15 seconds, 30 seconds, 1 minute, 5 minutes, 15 minutes, 30 minutes, 1 hours, 4 hours, 8 hours, 12 hours, 1 day, 7 days, 1 week, 1 month, 1 year, and/or the like, or any value therebetween in 1 second increments. Upon receiving an indication of selection of a particular value of the time granularity input 308 by the user 14, the client processor 58 may store the particular value as the time granularity of the graph 304 in the backtesting session data.

In one embodiment, the historic market instrument 305 may be, for example, a time-series data having the market value associated with a particular time value (e.g., timestamp). The historic market instrument 305 may be provided with time granularity within the graph 304 where the time granularity is a time delta between consecutive market values in the time-series data. For example, the historic market instrument 305 may have a time granularity of 5 minutes, resulting in the time-series data providing instrument values in 5-minute increments. As described below in more detail, the service processor 86 may generate the service buffer 95 of price data and transmit at least a portion of the service buffer 95 to the client processor 58 to cause the client processor 58 to store the received portion of the service buffer 95 with the client buffer 76 of price data.

In one embodiment, the service processor 86 may retrieve the value of the historic market instrument 305 from the service memory 82, such as from the database 94. In one embodiment, the database 94 storing the historic market instrument values is a non-relational database and/or a time-series database. The market value of the historic market instrument 305 may be, for example, stored as highly granular time-series data with a, e.g., per-tick granularity.

In one embodiment, the graph 304 may show instrument values for the historic market instrument 305 that have a time value at, or before, a simulation time 310. For example, as shown in FIG. 4, the simulation time 310 is shown as “17:54:59 (UTC)” and the primary user interface 30 with the backtesting session view 300 loaded with backtesting session data of the associated backtesting session may show the market values for the historic market instrument 305 only up to the market values having a time value at or before the simulation time 310 of 17:54:59 (UTC), and may not, for example, display the market values having the time value greater than the simulation time 310. As used herein, reference to “prior market value”, or the like, refers to market values of the historic market instrument 305 prior to the simulation time 310 and within a chart timeframe of the chart 302. The chart timeframe of the chart 302 may be a period of time currently displayed on the chart 302, representing a subset of the simulation timeframe.

Further, it should be understood that while the graph 304 only shows market values of the historic market instrument 305 having the time value up to and including the simulation time 310, the simulation data of the associated backtesting session may include the time-series data of the historic market instrument 305 stored in the client buffer 76 of the price data having a respective timestamp exceeding, or after, the simulation time 310. In some embodiments, the simulation data may include the time-series data of the historic market instrument 305 of the price data having a respective timestamp within the chart timeframe or, in other embodiments, within the simulation timeframe.

The backtesting session view 300 further provides an option menu 312 having one or more option 316a-n, shown as options 316a-g. In one embodiment, the option menu 312 may include an indicator option 316a, a place order option 316b, a hide navbar option 316c, a day option 316d (shown as ‘Mon’ indicating ‘Monday’), an economic calendar option 316e, an events option 316f (shown as ‘Show Events’), and a Goto option 316g. In one embodiment, the indicator option 316a, when selected by the user, causes the client processor 58 to display one or more indicators on the chart 302. In one embodiment, the place order option 316b, when selected by the user, causes the client processor 58 to display a place order dialog on the primary user interface 30. In one embodiment, the hide navbar option 316c, when selected by the user, causes the client processor 58 to hide the option menu 312 from the display on the chart 302. In one embodiment, the day option 316d, when selected by the user, causes the client processor 58 to toggle a “day of week” modal, e.g., when a cursor is within the chart 302 or over the graph 304 of the historic market instrument 305.

In one embodiment, the events option 316f, when selected by the user, causes the client processor 58 to toggle display of one or more event icon associated with the economic calendar on the chart 302 as described in application Ser. No. 19/329,334 entitled “System and Method for Backtesting Economic Calendar” filed on Sep. 15, 2025, the entire content of which is hereby incorporated herein by reference in its entirety. In some embodiments, a text of the events option may change based on whether the one or more event icons are displayed on the chart 302. For example, if the one or more event icons are displayed on the chart 302, the text of the events option 316f may be “Hide Events” to indicate to the user 14 that selection of the events option 316f when the one or more event icons are displayed on the chart 302 causes the client processor 58 to remove the one or more event icons from the chart 302. If the one or more event icons are not displayed on the chart 302, the text of the events option 316f may be “Show Events” to indicate to the user 14 that selection of the events option 316f when the one or more event icons are not displayed on the chart 302 causes the client processor 58 to draw the one or more event icons onto the chart 302.

In one embodiment, the Goto option 316g, when selected by the user, causes the client processor 58 to display a Goto menu having one or more Goto jumps on the primary user interface 30 as described in U.S. application Ser. No. 19/183,609 entitled “System and Method for Selection of Backtesting Time and Region” filed on Apr. 18, 2025, the entire content of which is hereby incorporated herein by reference in its entirety.

In one embodiment, the backtesting session view 300 includes a show journal input 320 operable to cause the client processor 58 to display a one or more journal entry or journal screenshot as described in U.S. Pat. No. 12,307,527 entitled “Security Trading Backtesting System Having an Interactable Journal” issued on May 20, 2025, the entire content of which is hereby incorporated herein by reference in its entirety.

In one embodiment, the backtesting session view 300 may further include a session-summary section 326 showing an account balance for the backtesting session, a realized profit and loss for the backtesting session, and an unrealized profit and loss for the backtesting session.

In one embodiment, the backtesting session view 300 may further include a display setting selector 328 operable to, when selected by the user via the primary user interface 30, cause the client processor 58 to modify a display size of the chart 302.

In one embodiment, the backtesting session view 300 may further display one or more position, such as an open position or a closed position, in a positions table 332 (e.g., as an open positions table, a closed positions table, or a positions table having both open and closed positions). The positions table 332 may include rows of positions the user 14 has taken within the backtesting session. The positions may be shown, for example, as a row in the positions table 332, however, the positions may be shown in other formats as well. The positions may include one or more position property, a selection of which may be displayed as columns of the positions table 332, such as a product value, a side value, a size value, a take profit value, a stop loss value, an unrealized gain value, and a realized gain value. As show, the positions table 332 may display open positions upon selection of an open positions input 333a (shown as selected in FIG. 4) and may display closed positions upon selection of a closed positions input 333b (shown as unselected in FIG. 4).

In one embodiment, the backtesting session view 300 may further display a play menu 338 having a speed controller 339, a play button 340, an increment selector 342, and a skip-forward button 344. Upon receiving an indication of a selection of an increment value within the increment selector 342, the client processor 58 may store the selected increment value with the backtesting session data. Further, the client processor 58 may receive an input indicative of selection of the play button 340 causing the session time of the backtesting session to increment by the increment value at a rate corresponding to a select rate on the speed controller 339. The skip-forward button 344 may cause the simulation time 310 to advance by the increment value. In one embodiment, the play menu 338 is only displayed on the primary user interface 30 if the backtesting instance ID of the particular backtesting session in the primary user interface 30 is the session manager of the backtesting session.

In one embodiment, the backtesting session view 300 may further include a user settings menu 336 operable to display, on the primary user interface 30, an icon associated with a logged-in user account for the user 14 and a settings menu. The user's user account may include account information, such as a user's name, an email address, a username, a user ID, custom settings, account properties, calendar settings, and/or the like.

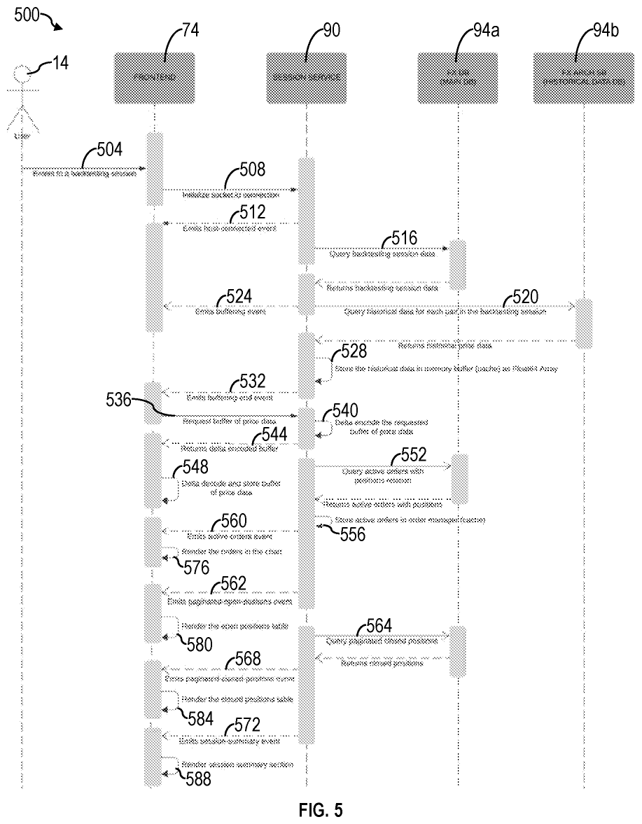

Referring now to FIG. 5, shown therein is a diagram of an exemplary embodiment of a session-service socket connection process 500 constructed in accordance with the present disclosure. As shown in FIG. 5, when the user 14 enters a backtesting session (step 504), such as by entering a challenge match by the user 14 (described below), the client processor 58 of the user device 18 executing the user application 74 may send an initialization signal 508 to the service device 22 to cause the service device 22 to initialize an event-based communication session. The initialization signal 508 may include, for example, at least account information, such as a user ID, and a backtesting session ID or a challenge ID. The initialization signal 508 may further include a backtesting instance ID to identify a particular backtesting instance of the backtesting session. In some embodiments, if no other backtesting instance ID are associated with the backtesting session, then the backtesting instance ID may be provided as the session manager of the backtesting session. In some embodiments, the event-based communication session may utilize web socket communication via the network 26. In other embodiments, the event-based communication session may be, for example, a gRPC session.

In response to receiving the initialization signal 508, the service processor 86, executing the backtesting application 90, such as the session module 90a and/or the order module 90b, may establish the event-based communication session with the user device 18 based on the initialization signal 508 and may, in some embodiments, emit a host-connected event 512. The service processor 86 may then query backtesting session data (event 516), e.g., retrieve the backtesting session data for the backtesting session based on one or more of the backtesting session ID and the account information, from the service memory 82, such as from the database 94.

After retrieving the backtesting session data, the service processor 86 may select historical data for each financial instrument in the backtesting session (event 520). In some embodiments, the service processor 86 may emit a buffering event 524, e.g., simultaneously with the selection of the historical data.

After selection of the historical data, the service processor 86 may iterate through the historical data for each financial instrument to generate the price data stored in the service buffer 95 (step 528). The price data may be stored in the service buffer 95, for example, as a Float64 array. The price data stored in the service buffer 95 may be based on a buffer type (e.g., a second-type buffer or a minute-type buffer) of the service buffer 95. For example, the service buffer 95 may be a second-type buffer if one or more of: the time granularity value of the time granularity input 308 or increment value of the increment selector 342, have a value within a second-range, e.g., a value below 1 minute. The service buffer 95 may be a minute-type buffer if the time granularity value of the time granularity input 308 is 1 minute or greater. The buffer type may be associated with, or may be included as part of, the backtesting session data.

When the service processor 86 has completed parsing the historical data into the service buffer 95, or when the service buffer 95 has reached a predetermined maximum buffer length of price data, the service processor 86 may emit a buffering-end event 532. In some embodiments, the predetermined maximum buffer length may be based, for example, on the buffer duration. For example, the predetermined maximum buffer length may be time based, such that the buffer holds price data having timestamps spanning a period of time, such as two weeks. Alternatively, the predetermined maximum buffer length may be quantity based, such that the buffer holds a maximum quantity of price data (e.g., having timestamps after the simulation time 310 as described below).

In response to receiving the buffering-end event 532, the client processor 58 of the user device 18 may request a buffer of price data for the financial instrument of the backtesting session (step 536). The buffer of price data may include at least a buffer start timestamp and, e.g., an array of, the price data for each financial instrument. Each price datum in the array of price data may be referred to as a record of price data. The array of the price data may include a value timestamp and a market value and may be, for example, an ordered array of the price data based on the value timestamp. The buffer start timestamp may be a first value timestamp of the ordered array of the price data. The buffer start timestamp may be after the simulation time, for example, 1 second after the simulation time for a second-type buffer or 1 minute after the simulation time for a minute-type buffer.

The service processor 86 may delta-encode at least a portion of the service buffer 95 of price data (step 540) and return the delta-encoded buffer of price data (step 544). The service processor 86 may delta-encode at least a portion of the service buffer 95 of price data (step 540) by selecting a first price data as a key price data having a key value timestamp and key market value and, for each remaining price data of the array of the price data, may determine a delta price data comprising a delta time and a delta value. In this way, the delta-encoded buffer of price data may include the first price data of the array of price data and a respective delta price data for remaining price data in the array of price data. In one embodiment, for the second-type buffer, the delta time may be as small as one second while for the minute-type buffer, the delta time may be as small as one minute. Thus, when the graph 304 does not show increment values in time increments under 1 minute, the delta-encoded buffer of price data may not include delta price data for the financial instrument at delta times less than 1 minute apart. By utilizing the delta-encoded buffer of price data, the service device 22 achieves benefits over traditional methods, such as increased flexibility, faster load times, and smaller network and memory requirements.

For example only, if the array of price data was described as an ordered array based on the value timestamp of the price data such as by pseudocode “[{date: “Oct. 17, 2025 10:00:00”, price: 10000.00}, {date: “Oct. 17, 2025 10:00:10”, price: 10000.10}, {date: “Oct. 17, 2025 10:00:30”, price: 10010.10}]”, then the service processor 86 may iteratively process the price data in the array into the delta-encoded buffer of price data, such that the first price data (e.g., {date: “Oct. 17, 2025 10:00:00”, price: 10000.00}) is a key price data, the second price data (e.g., {date: “Oct. 17, 2025 10:00:10”, price: 10000.10}) is encoded as a first delta price data having a value of “{+10, +0.10}” (e.g., the difference between “date: “Oct. 17, 2025 10:00:00”” of the key value timestamp and “date: “Oct. 17, 2025 10:00:10”” of the value timestamp of the second price data as the first delta time and the difference between “price: 10000.00” of the key market value and “price: 10000.10” of the second market value as the first delta value), and the third price data (e.g., {date: “Oct. 17, 2025 10:00:30”, price: 10010.10}) is encoded as a second delta price data having a value of “{+20, +10.00}” (e.g., the difference between the second price data and the third price data), resulting in a delta-encoded buffer of price data of “[{date: “Oct. 17, 2025 10:00:00”, price: 10000.00}, {+10,+0.10}, {+20, +10.00}]”. In this example, the delta-encoded buffer of price data may be a second-type buffer, thus the delta time includes increments of less than 1 minute (e.g., in the order of seconds).

In this way, the array of price data can be recreated (e.g., delta-decoded) by selecting the key price data as a first delta-decoded price data and sequentially and iteratively calculating the remaining price data of the array by, for each delta price data, adding or combining the delta time with the prior delta-decoded value timestamp as the value timestamp of the respective price data and the delta value with the prior delta-decoded market value as the market value of the respective price data. For example, the second price data may be determined by delta-decoding the delta-encoded buffer of price data, such that the first price data is the key price data “{date: “Oct. 17, 2025 10:00:00”, price: 10000.00}” and the second price data is calculated as “Oct. 17, 2025 10:00:00” (i.e., the key value timestamp) summed with “+10” (i.e., the first delta time), resulting in a second value timestamp of {date:“Oct. 17, 2025 10:00:10”}, and “10000.00” (i.e., the key market value) summed with “+0.10” (i.e., the second delta value) resulting in a second market value of {price: 10000.10}. Thus, the second price data is delta-decoded as “{date: “Oct. 17, 2025 10:00:10”, price: 10000.10}”. In this embodiment, each delta price data is calculated as a difference between a particular price data in the array and a prior price data in the array.

In some embodiments, the service processor 86 delta-encoding at least the portion of the service buffer 95 of price data (step 540) may include providing multiple key price data periodically within the delta-encoded buffer of price data. For example only, every hundredth or every thousandth price data in the array of price data may be provided as a respective key price data. For a nonlimiting example, if 25,000 price data records are provided in the service buffer, the delta-encoded buffer of price data may include 25 key price data with each key price data being followed by 999 delta-encoded buffer of price data.

In other embodiments, each delta price data may be calculated as a difference between a particular price data in the array and the key price data. In this embodiment, recreating (e.g., delta-decoding) the array of price data from the delta-encoded buffer of price data may include selecting the key price data as a first delta-decoded price data and sequentially and iteratively calculating the remaining price data of the array by, for each delta price data, adding or combining the delta time with the key value timestamp to create the value timestamp of the respective price data and the delta value with the key market value to create the market value of the respective price data.

The backtesting system 10 solves the technical problem of large data transfers of the price data and a slow response to progression through the backtesting session by the service processor 86 delta-encoding the price data to significantly reduce an amount of data transmitted from the service device 22 to the user device 18 and significantly reducing the transfer time of the price data from the service device to the user device, thereby allowing user devices 18 to more quickly receive the price data to process and display on the primary user interface 30. Further, by maintaining the service buffer 95, the backtesting system 10 may further overcome the technical problems inherent in querying large corpus of data being a time-consuming process by buffering the price data in the service buffer such that when the user device 18 requests price data, the service processor 86 is not required to query the historical data after receiving the request and before being able to respond to the request. This arrangement enables the service device 22 to more quickly respond to the user device 18 without traditional delays.

The client processor 58, upon receiving the delta-encoded buffer of price data, may delta-decode the buffer of price data and store the delta-decoded buffer of price data in the client memory 66, such as with the client buffer 76 of the price data (step 548). The client processor 58 may then load or render the graph 304 of the historic market instrument 305 on the chart 302 of the primary user interface 30 displayed on the output device 54.

After returning the delta-encoded buffer of price data to the user device 18, the service processor 86 may query for one or more active order with one or more positions (step 552), e.g., from the service memory 82. The service processor 86 may then store the active orders in the service memory 82 (step 556), such as in an order manager cache. After storing the active orders in the service memory 82, the service processor 86 may emit an active-orders event 560 having the active orders and may emit a paginated-open-positions event 562 having the open positions. The service processor 86 may then query paginated closed positions (step 564), e.g., from the service memory 82 and emit a paginated-closed-positions event 568 having the paginated closed positions. Finally, the service processor 86 may emit a session-summary event 572. The session-summary event 572 may include, for example, session summary data including a ticker step, the increment value selected from the increment selector 342, backtesting session data (including the current session time), and statistics regarding the backtesting session. The statistics may include, for example, backtesting session data, financial instrument data, current account balance, realized profit and loss, unrealized profit and loss, status of the session, and the like, or combinations thereof, for example. In step 588, the statistics may be shown or rendered, for example, in the session-summary section 326 of the primary user interface 30 (shown in FIG. 4).

In one embodiment, the client processor 58, receiving the active-orders event 560 may render the active orders in the chart 302 (step 576). Further, upon receiving the paginated-open-positions event 562, the client processor 58 may render the positions table 332 on the primary user interface 30 (step 580) to include the retrieved open positions.

In one embodiment, the client processor 58, receiving the paginated-closed-positions event 568 may render the paginated closed positions (step 584) in the primary user interface 30, such as in the positions table 332, upon selection of the closed positions input 333b (FIG. 4).

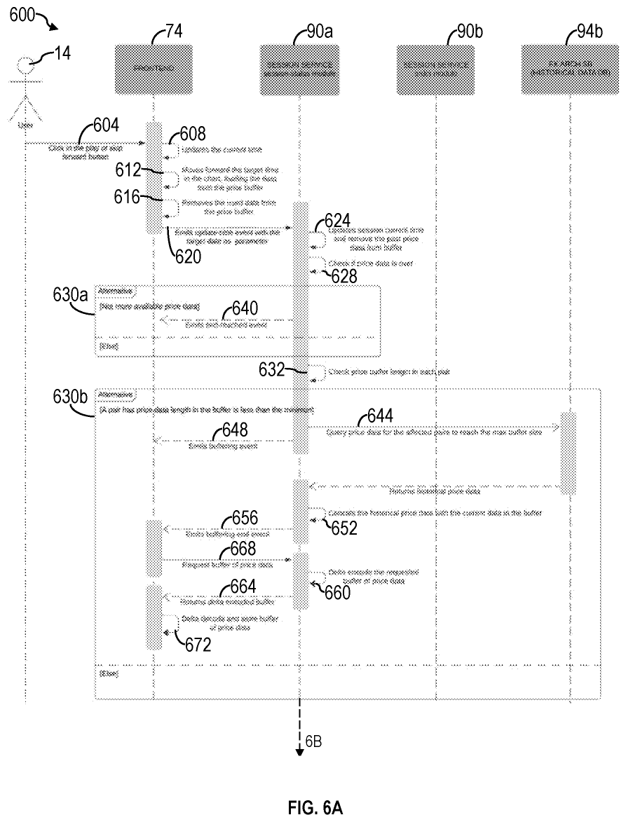

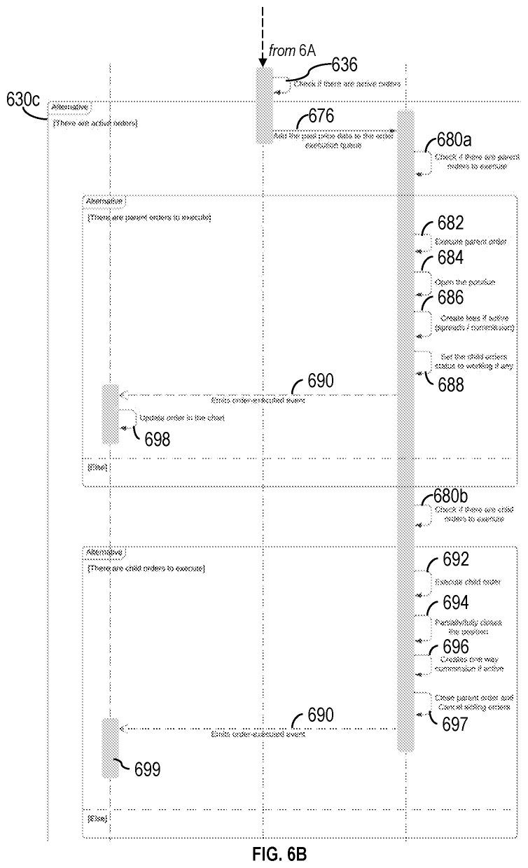

Referring now to FIGS. 6A-6B, in combination, shown therein is a diagram of an exemplary embodiment of a session-service update process 600 constructed in accordance with the present disclosure. The client processor 58 may receive an input from the input device 50, such as: by selection of one or more of: a goto input such as the goto jump under the Goto option 316g (FIG. 4), a play input such as a play button 340 (FIG. 4), and a skip input such as a skip-forward button 344 (FIG. 4); by input of a key, key press, or key combination (e.g., from a keyboard, such as, by way of example and not limitation, a space bar, or a combination of key presses, such as, by way of example and not limitations, pressing the control key and the space bar); and by interaction with the graph 304 such as selection of a candlestick of the historic market instrument 305 on the graph 304, and/or the like; by the user 14 in the primary user interface 30.

As shown in FIG. 6A, when the client processor 58 receives the input from the input device 50 (step 604), the client processor 58 of the user device 18 executing the user application 74 may iteratively: update the simulation time 310 from the simulation time to a target time (step 608); move forward the simulation time 310 to the target time in the chart 302 by loading price data from the client buffer 76 corresponding to price data having the price timestamp equal or prior to the target time (step 612); and remove the loaded price data from the client buffer 76 (step 616). For each iteration increasing the simulation time 310 by the time increment, the client processor 58 may emit an update-time event with the target time and (optionally) a backtesting session ID as a parameter (event 620). Upon receiving an indication of a selection of an increment value within the increment selector 342, the client processor 58 may store the selected increment value with the backtesting session data. In some embodiments, the client processor 58 may only emit the update-time event with the target time if the backtesting session ID of the particular backtesting session instance in which the input to the primary user interface 30 was received is the session manager of the backtesting session.

The service processor 86 executing the session module 90a may receive the update-time event with the target time and may update a current session time stored in the service memory 82 and remove price data having the price timestamp of or prior to the current session time (step 624). The service processor 86 may receive the update-time event with the target time and may update a current session time stored in the service memory 82 if the backtesting session ID of the update-time event is the session manager. The service processor 86 may then check for price data in the service buffer 95 (step 628) to determine whether to execute a first subprocess 630a, check a length of the price data in the service buffer 95 (step 632) to determine whether to execute a second subprocess 630b, and check for active orders (step 636) to determine whether to execute a third subprocess 630c. In one embodiment, the service processor 86 may execute a separate instance of the session module 90a, each backtesting session associated with users 14 connected to a particular backtesting challenge.

If the service processor 86 determines that there is no remaining price data in the service buffer 95 at step 628, the service processor 86 may execute the first subprocess 630a to emit an end-reached event 640 and exit the session-service update process 600.

If the service processor 86 determines that the length of the price data in the service buffer 95 (from step 632) is at or below a minimum buffer length, the service processor 86 may execute the second subprocess 630b. Upon execution of the second subprocess 630b, the service processor 86 may query historical data for the financial instrument (step 644) and may, (optionally, simultaneously) emit a buffering event 648. The service processor 86 may query the historical data from the service memory 82, for example, such as from the second database 94b storing the historical data until the service buffer 95 reaches the predetermined maximum buffer length. For example, the predetermined maximum buffer length may be between about 25,000 records and 50,000 records. It should be understood that a person having ordinary skill in the art may select the predetermined maximum buffer length different from between 25 k records and 50 k records based on, for example, hardware limitations and performance expectations. Similarly, the minimum buffer length may be a predetermined minimum buffer length. The minimum buffer length may be between, for example, 10,000 records and 30,000 records and may depend on the selection of the predetermined maximum buffer length. In some embodiments, the minimum buffer length may be selected to be between about 20% and 60% of the maximum buffer length.

The service processor 86 may determine a length of the price data in the service buffer 95 and may query a particular set of price data records from the historical data based on a difference between the length and the maximum buffer length, such that the queried price data includes subsequent price data, i.e., price data having a price timestamp immediately subsequent to the price timestamp of the greatest price timestamp of the price data in the service buffer 95.

The service processor 86, upon receiving the queried price data may include the price data in the service buffer 95 of price data (step 652), such as by concatenating the queried price data to the service buffer 95, and may emit a buffering-end event 656. Upon receiving a buffer request for a subsequent buffer of price data, the service processor 86 may delta-encode the requested buffer of price data (step 660) and may return the delta-encoded buffer to the requestor (step 664). In one embodiment, the service processor 86 may further include the current session time with the delta-encoded buffer in response to the request of the buffer of price data. In other embodiments, the service processor 86 may further include the backtesting session data for the backtesting session with the delta-encoded buffer in response to the request of the buffer of price data.

The client processor 58, receiving the buffering-end event 656, may send the buffer request to the service device, the buffer request requesting the subsequent buffer of price data for the financial instrument of the backtesting session (step 668). In one embodiment, upon receiving the delta-encoded buffer, the client processor 58 may delta-decode and store the subsequent buffer of price data in the client buffer 76 (step 672), such as by concatenating the received buffer of price data with the client buffer of price data. In other embodiments, upon receiving the delta-encoded buffer, the client processor 58 may delta-decode and store the buffer of price data in the client buffer 76 (step 672) by replacing the price data in the client buffer with the delta-decoded buffer of price data.

In one embodiment, if the backtesting instance ID of the particular backtesting session receiving the buffer of price data is not the session manager of the backtesting session, the client processor 58 may update the simulation time 310 based on the received current session time.

If the service processor 86 determines that there are active orders (from step 636), the service processor 86 may execute the third subprocess 630c. Upon execution of the third subprocess 630c, the service processor 86 may add past price data to an order execution queue (step 676). The service processor 86 may then check for parent orders (step 680a) and check for child orders (step 680b). Each parent order may be, for example, a buy/sell order to open a position and may include one or more child orders. Each child order may be, for example, a take profit/stop loss, which helps to manage the parent order. Child orders sharing a parent order, e.g., having a common parent order, may be related to one another as sibling orders.

In one embodiment, upon determining that there are parent orders to execute in step 680a, the service processor 86 may execute the parent order (step 682), open the position (step 684), create fees (step 686), set child orders status to working (step 688) and emit an order-executed event 690 having order data, such as parameters indicative of one or more of: the parent order, the child orders, the fees (if applicable), and the opened position.

In one embodiment, the service processor 86 may only create the fees (step 686) if the user 14 has activated fees calculations. The service processor 86 may determine whether the user 14 has activated fees calculations based on the calculate fees option of the backtesting session data for the backtesting session. In some embodiments, the user 14 may select the calculate fees option when creating a backtesting session. In other embodiments, the user 14 may select the calculate fees option as part of the account information for the user's user account. The created fees may include, for example, one or more of: spreads, commissions, one-way commissions, and the like, or combinations thereof.

In one embodiment, the client processor 58 may receive the order-executed event 690 and may update the primary user interface 30 based on the executed parent order (step 698). For example, the client processor 58 may add the position opened in step 684 to the positions table 332 (if the positions table 332 is displaying open positions, for example).

In one embodiment, upon determining that there are child orders to execute in step 680b, such as by identifying active child orders, the service processor 86 may execute the active child order (step 692), close the position (step 694), create commission (step 696), close family orders (step 697), and emit the order-executed event 690 having order data, such as parameters indicative of one or more of: the child order, parent order, the fees (if applicable) and the closed position. In one embodiment, closing the position (step 694) may include the service processor 86 either partially or fully closing the position. In this way, if a parent order is open, and if child orders are active then, when the simulation time advances and the price of the financial instrument reaches a point where the child orders can execute, the open position may be partially or completely closed.

In one embodiment, closing the family orders (step 697) may include the service processor 86 closing the parent order of the child order and cancelling sibling orders (e.g., other child orders of the parent order).

In one embodiment, the client processor 58 may receive the order-executed event 690 and may update the primary user interface 30 based on the executed child order (step 699). For example, the client processor 58 may add the position closed in step 694 to the positions table 332 (if the positions table 332 is displaying closed positions, for example). In one embodiment, the client processor 58 may further move a position from the open positions to closed positions in response to the order-executed event 690 generated after closing the position (step 694) and closing the family orders (step 697). The client processor 58 may further remove the parent order from the chart 302, remove all child orders from the chart 302, and render the closed position on the positions table 332.

In one embodiment, one or more of the events emitted by the service processor 86 may include the current session time as a property. The client processor 58, receiving the emitted event may update the simulation time 310 of the backtesting session in the primary user interface 30 when the backtesting session instance in the primary user interface 30 is not the session manager.

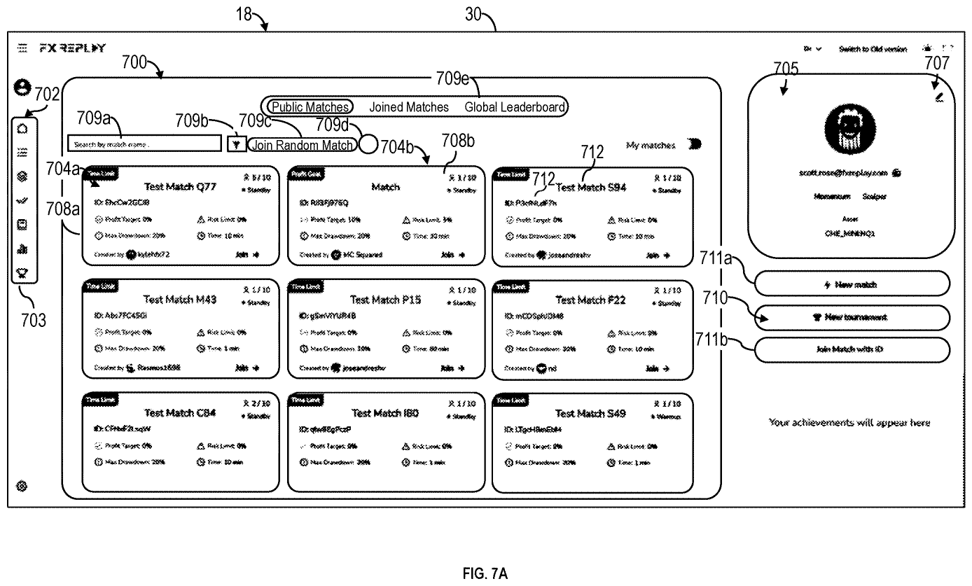

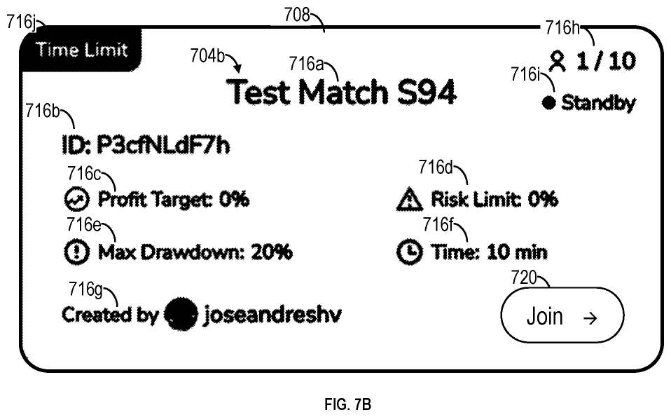

The processes described above in connection with FIGS. 5-6B provide the technical infrastructure for creating and managing multi-participant trading competitions within the backtesting system 10. In some embodiments, the backtesting system 10 may further be operable to allow users 14 to create, join, and participate in multi-participant trading competitions, as described in more detail below with reference to FIGS. 7A-15.

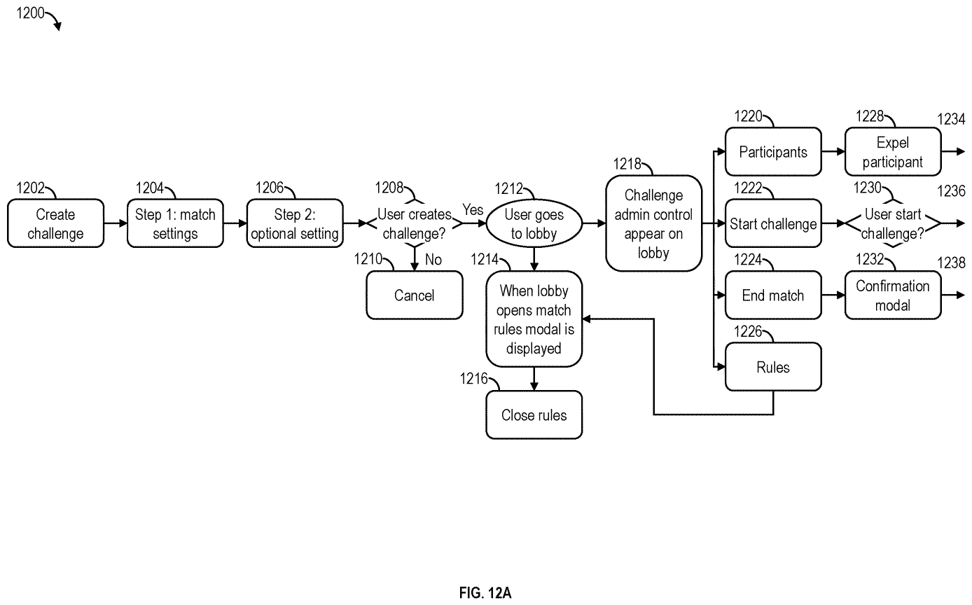

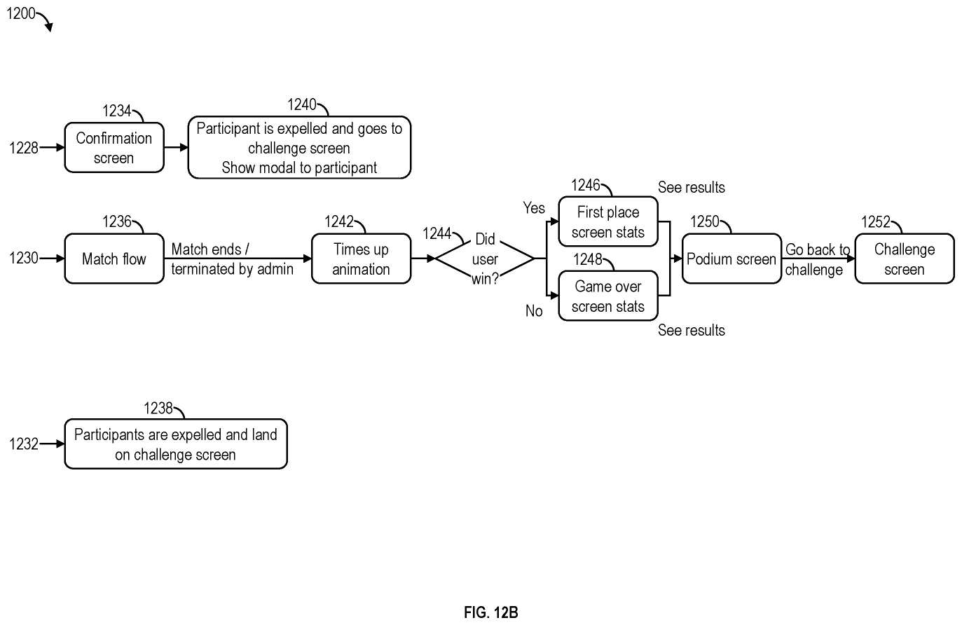

Referring now to FIG. 7A, shown therein is an illustration of an exemplary embodiment of the user device 18 displaying the primary user interface 30 with a match dashboard 700 constructed in accordance with the present disclosure. The primary user interface 30 may further include a navigation bar 702 and a challenges option 703 that, upon selection (e.g., step 1101 in FIG. 11), causes the client processor 58 to provide the match dashboard 700 on the primary user interface 30. As shown, the match dashboard 700 may display one or more match 704a-n. In some embodiments, the match dashboard 700 may only display match 704 to which the user 14 has access or may otherwise join. In one embodiment, each match 704 may be displayed as a match card 708, such as a first match card 708a and a second match card 708b. An exemplary match card 708 is shown in FIG. 7B and described in more detail below. Each match 704 may comprise a plurality of match properties 712, which may be set by a tournament administrator as described below. As shown, the client processor 58 may display the primary user interface 30 of the backtesting application 90 on the user device 18.

The match dashboard 700 may include one or more match control 709a-n, such as a match search 709a enabling the user 14 to input a query to search one or more of the plurality of match properties 712, for example, a match name, a match ID, a challenge ID, a challenge name, an availability control (e.g., publicly available wherein any user 14 may join, privately available wherein only particular users 14 allowed or otherwise added by the tournament administrator, or those users 14 with a password/passkey may join, semi-publicly available wherein any user 14 having a particular link may join), a risk limit, a profit target, a max drawdown, a match time limit, a match creator, a match status, a match type, and/or the like or a combination thereof. Upon entering the query into the match search 709a, the client processor 58 may display only match cards 708 associated with matches having one or more match property 712 satisfying the query. In some embodiments, the client processor 58 may execute the query as the user 14 is typing into the match search 709a, while in other embodiments, the client processor 58 may execute the query after the user 14 indicates to begin the search, such as by pressing a key via the input device 50, by detecting a pause between characters input by the user 14, or by providing the user 14 with a search input (such as a search button to cause the client processor 58 to begin the search).

The match dashboard 700 may include a match filter 709b enabling the user 14 to select one or more filter to apply respective filter criteria to one or more of the plurality of match properties 712. Upon selection of the filter, the client processor 58 may display only match cards 708 associated with challenges having one or more match property 712 meeting the filter criteria.

The match dashboard 700 may further include a random match input 709c. Upon selection of the random match input 709c, the client processor 58 may transmit a join random match signal to the service processor 86 to cause the service processor 86 to randomly select a match having availability (e.g., having a number of waiting participants less than a number of max participants and not yet started, such as having a status of “standby,” “waiting” or the like, having a public availability, and/or the like or a combination thereof). While shown with text as “join random match”, in some embodiments, each user account may be associated with a performance metric and the service processor 86 may select an available match wherein the participants have similar performance metrics such that a less experienced or skilled user may not be placed in a match having other users with much more experience or skill.

The match dashboard 700 may further include a refresh match list input 709d. Upon selection of the refresh match list input 709d, the client processor 58 may request from the service processor 86 one or more match having availability. The requested one or more matches may be requested based on one or more of the query and the selected filter, when supplied by the user 14.

In one embodiment, the match dashboard 700 may further include a new tournament input 710, a new match input 711a and a join match with ID input 711b. Upon selection of the new tournament input 710, the client processor 58 may first (optionally) determine whether the user 14 has permissions to create a new tournament.

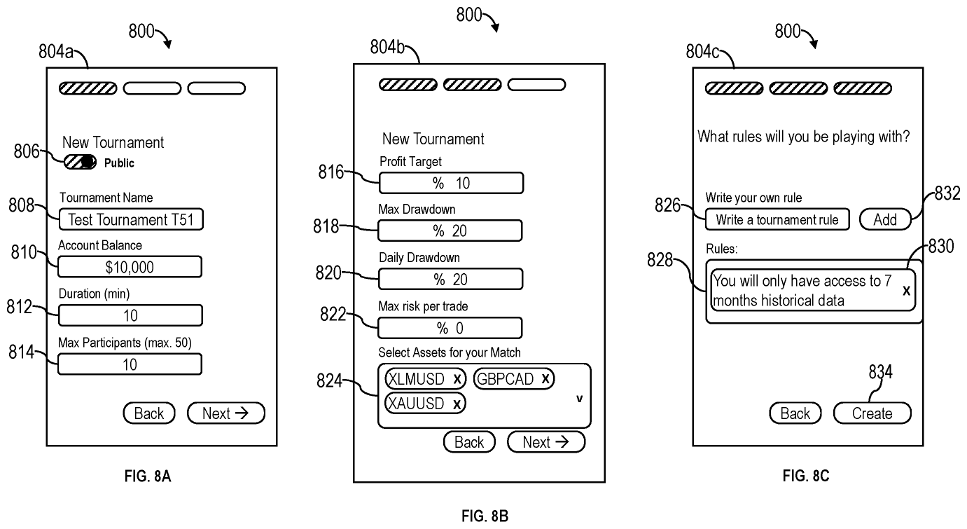

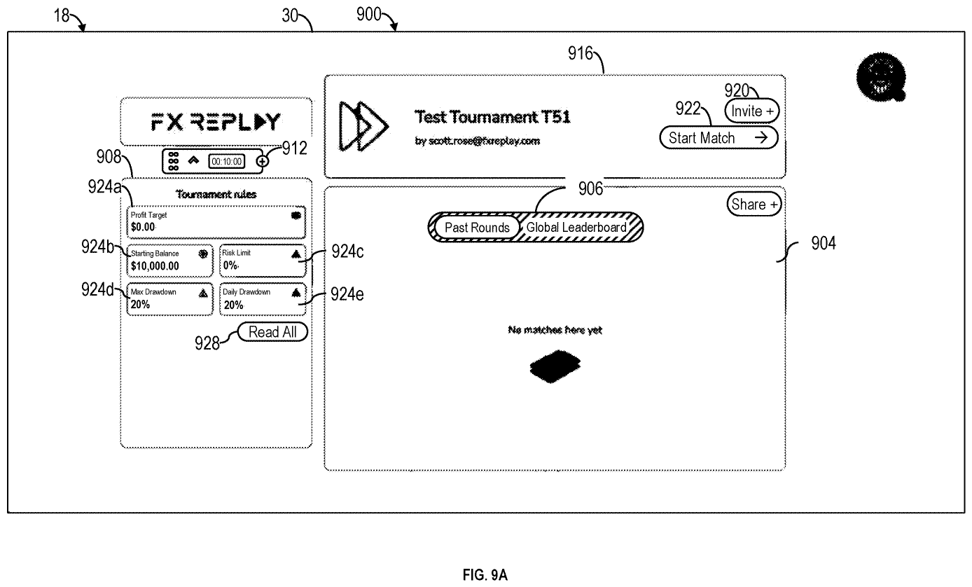

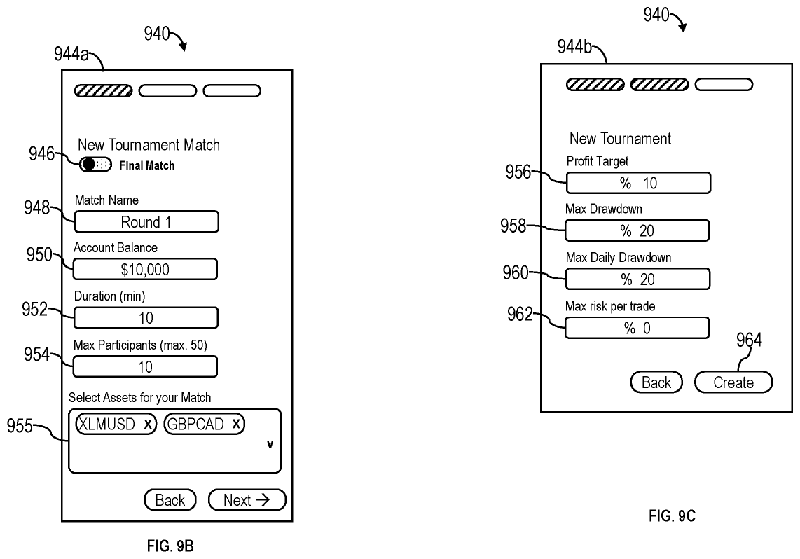

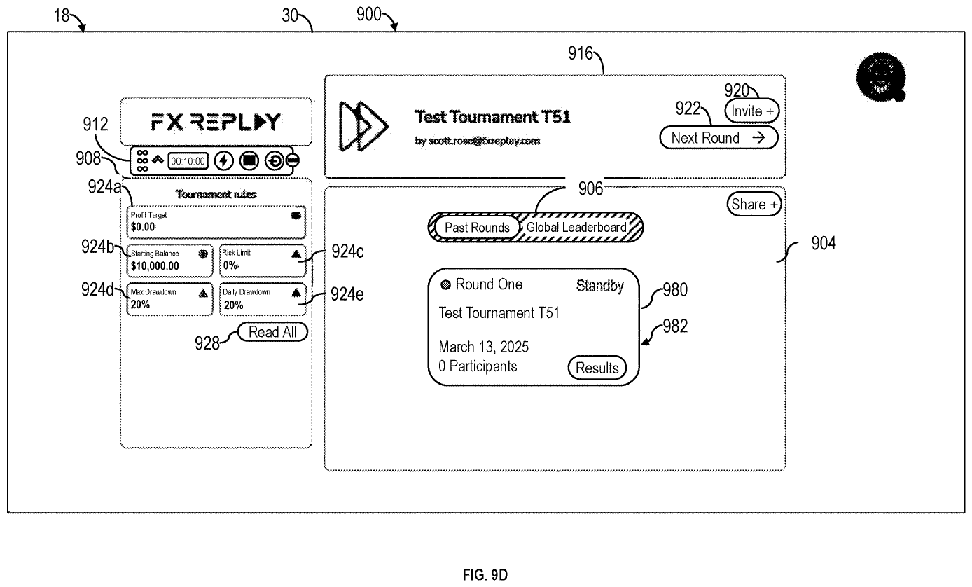

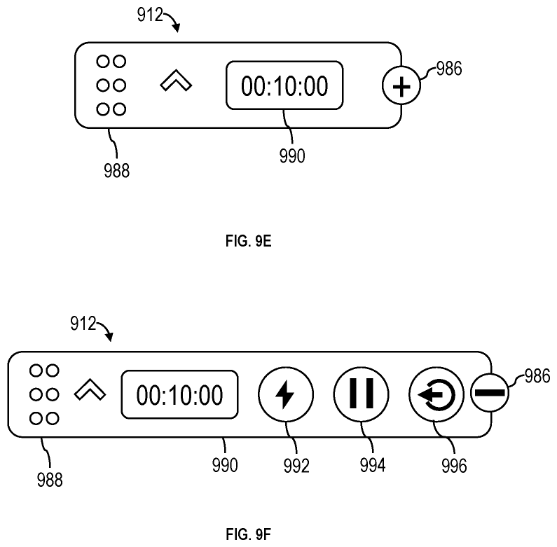

Upon selection of the new tournament input 710, the client processor 58 may display a new tournament modal 800 as shown in FIGS. 8A-8B and described in more detail below. Upon selection of the new match input 711a, the client processor 58 may display a new match modal 940, as shown in FIGS. 9B-9C, for example, and described in more detail below.

Upon selection of the join match with ID input 711b, the user 14 may be provided with an ID input operable to receive the match ID from the user 14 via the input device 50, for example. The client processor 58 may transmit a join match signal having the match ID and the user ID to the service processor 86 to cause the service processor 86 to associate the user ID with the match ID.

Referring now to FIG. 7B, shown therein is an illustration of an exemplary embodiment of the match card 708 constructed in accordance with the present disclosure. The match card 708 may display one or more of the plurality of match properties 712 as a property field 716. For example, as shown in FIG. 7B, the property fields 716 may include a match name 716a, a match ID 716b, a profit target 716c, a risk limit 716d, a max drawdown 716e, a match time limit 716f, a match creator 716g, a participant queue 716h, a match status 716i, and a match type 716j. In other embodiments, the property fields 716 may include fewer or more match properties. In one embodiment, the match card 708 may further include a join input 720 that, upon selection by the user 14 via the input device 50 may cause the client processor 58 to send a signal having at least a user ID and respective match ID to the service processor 86 to cause the service processor 86 to associate the user ID with the match ID, such as in the service memory 82 for example. The participant queue 716h may show, for example, a number of participants already in the match and a number of spots available in the match, e.g., a number of user IDs associated with the match ID of the match associated with the particular match card 708.

It should be understood that the match card 708 shown in FIG. 7B is an exemplary match card 708 of the plurality of match cards 708a-n shown in the match dashboard 700. Each match card 708 in the match dashboard 700 may be constructed in accordance with the match card 708 shown in FIG. 7B.

Referring now to FIGS. 8A-8C, shown therein is an illustration of an exemplary embodiment of the user device 18 displaying the primary user interface 30 with the match dashboard 700 showing the new tournament modal 800 constructed in accordance with the present disclosure. The new tournament modal 800 may be provided to the user 14 to receive one or more tournament property and/or one or more default new match property for each match created as part of the particular tournament. Once a particular user 14 has created a tournament, that particular user 14 may be considered a tournament administrator and the user device 18 used by the tournament administrator may be considered an administrator device. In some embodiments, the tournament administrator may not be a player in matches having the same challenge ID as the tournament for which the particular user 14 is also a tournament administrator. In some embodiments, the one or more tournament properties may include the one or more default new match properties. The new tournament modal 800 may be provided as a multi-step form having a first new tournament form 804a shown in FIG. 8A, a second new tournament form 804b shown in FIG. 8B, and a third new tournament form 804c shown in FIG. 8C. While the new tournament modal 800 is described as a modal, in other embodiments, the new tournament modal 800 is not limited to being a modal, and may be, for example, any type of UI/UX element as described above and/or the like, or a combination thereof.

The first new tournament form 804a shown in FIG. 8A may include one or more input corresponding to the one or more tournament property and/or the one or more default new match property such as an availability control input 806 operable to receive an input of the availability control, a tournament name input 808 operable to receive an input corresponding to the tournament name, a starting balance input 810 operable to receive an input for a default match starting balance that all players (e.g., users 14 participating in the match) start with, a match duration input 812 operable to receive an input for a default match duration (in “real world” time, i.e., actual time, not simulation time), and a max participants input 814 operable to receive an input for a default number of maximum participants.

The second new tournament form 804b shown in FIG. 8B may include one or more input corresponding to the one or more tournament property and/or the one or more default new match property such as a match default profit target input 816 operable to receive an input of a default match profit target percent, a max drawdown input 818 operable to receive an input corresponding to a default match drawdown percent, a daily drawdown input 820 operable to receive an input for a default match daily drawdown percent, a max risk input 822 operable to receive an input for a default match max risk per trade percent, and a default asset list input 824 operable to receive one or more input for a default match session pair list. In one embodiment, the default match profit target percent, when filled out, will cause the match to end when any participant in the match hits the profit target percent in the participant's backtesting session regardless of the match duration. The default max drawdown percent, when filled out, will cause the match to end for the participant when the max drawdown percent is reached in the participant's backtesting session. The max daily drawdown percent is a maximum a participant may lose in one trading day in the participant's backtesting session. The max risk per trade percent is a maximum amount a participant can risk per trade in the participant's backtesting session.

The third new tournament form 804c shown in FIG. 8C may include one or more input corresponding to the one or more tournament property and/or the one or more default new match property such as a custom rule input 826 operable to receive a custom rule input, a rules list input 828 operable to display one or more active rules 830 such as the one or more custom rule and one or more selected predetermined rules. In one embodiment, the custom rule input may be added to the rules list input 828 upon indication by the user 14 such as via selection of an add rule input 832. Each of the one or more active rules 830 in the rules list input 828 may be displayed in the match card 708, for example.

It should be understood that while the one or more inputs corresponding to the one or more tournament property and/or the one or more default new match property are shown across multiple forms 804, in some embodiments, all of the one or more inputs may be provided on a single modal or form, fewer modals or forms, or additional modals or forms. In some embodiments, the new tournament modal 800 may include additional inputs corresponding to the one or more tournament property and/or the one or more default new match property or fewer inputs corresponding to the one or more tournament property and/or the one or more default new match property. For example, the new tournament modal 800 may exclude one or more of the match default inputs from the new tournament modal 800 and instead provide predetermined values for the excluded one or more match defaults in the tournament properties.

In one embodiment, upon selection of a create input 834 by the user 14, e.g., via the input device 50, the client processor 58 may transmit each input of the multiple forms 804 of the new tournament modal 800 to the service processor 86 to create the new tournament having tournament properties corresponding to the one or more inputs of the new tournament modal 800 and may add the user 14, that selected the create input 834, as a tournament administrator for the newly created tournament.

In one embodiment, after the new tournament has been created, the client processor 58 may redirect the user device 18 to a tournament administration view 900 such that the tournament administration view 900 is displayed in the primary user interface 30 of the output device 54. In some embodiments, a tournament administrator may be the tournament administrator for more than one tournament.

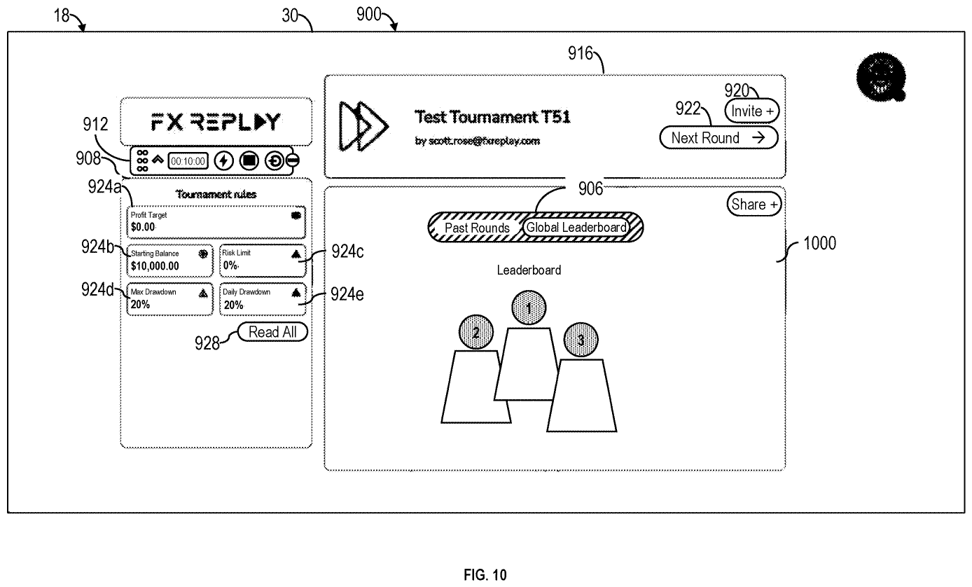

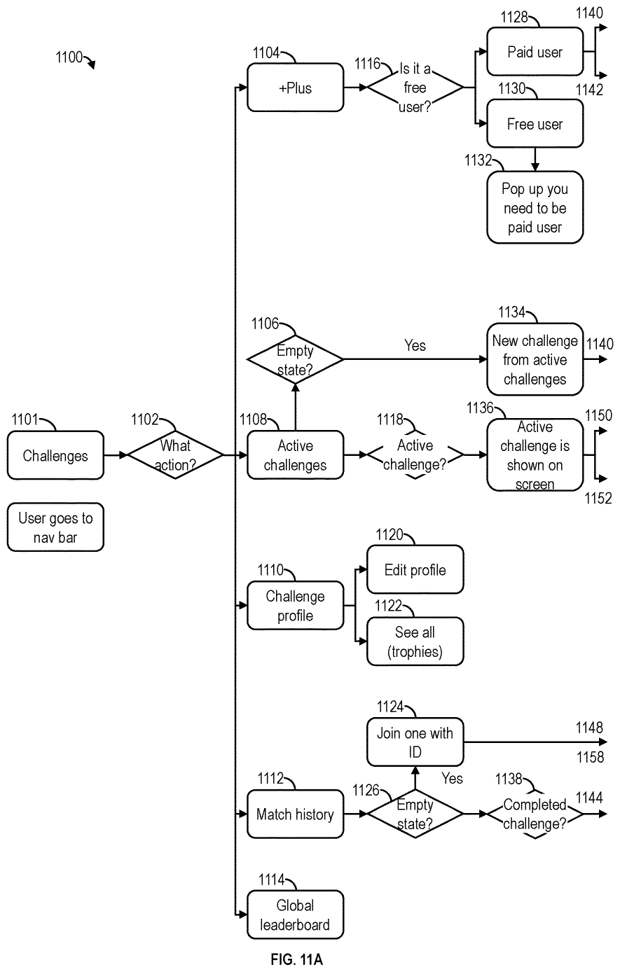

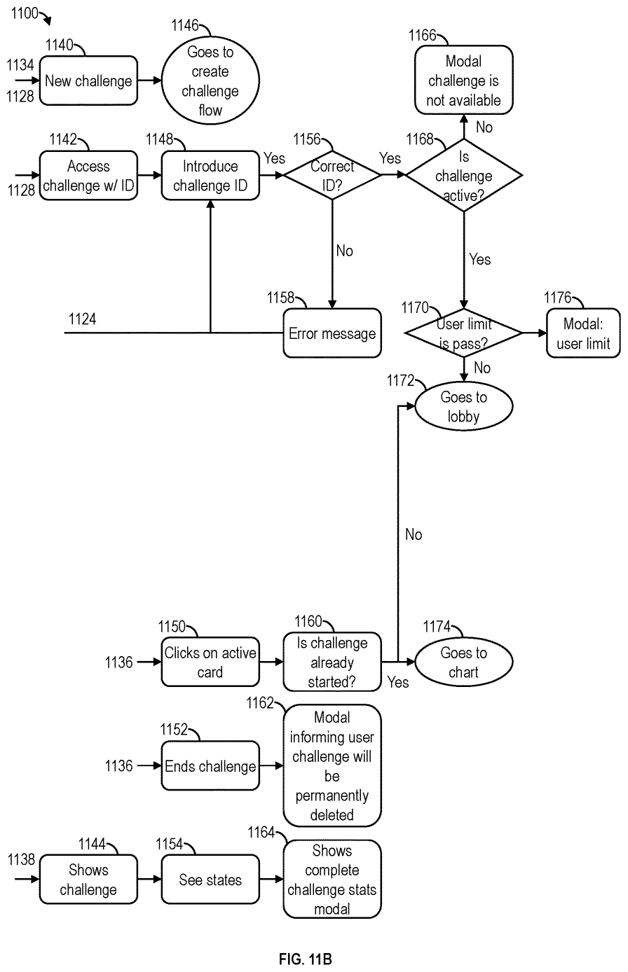

Referring now to FIG. 9A, shown therein is an illustration of an exemplary embodiment of the user device 18 displaying the primary user interface 30 with the tournament administration view 900 constructed in accordance with the present disclosure. The tournament administration view 900 may show a match list 904 when a selector 906 is selected to show “Past Rounds” (which may also include incomplete, or unfinished matches), a tournament rules pane 908, a match controller 912 (shown in more detail in FIGS. 9E-9F), and a tournament header panel 916. In one embodiment, when the selector 906 is selected to show “Global leaderboard” the client processor 58 may display a global leaderboard 1000 as shown in FIG. 10.

In one embodiment, the tournament administration view 900 may further include an invite input 920 that, upon selection of the invite input 920 will provide a link to the tournament to the tournament administrator. The tournament administrator may then provide the link to one or more user 14 (e.g., potential participant) that, when navigated to by the potential participant will allow the potential participant to join a match hosted by that particular tournament.

In one embodiment, the tournament administration view 900 is provided with the match list 904 showing one or more hosted match 980 (shown in FIG. 9D and discussed below). A hosted match may be, for example, any match (e.g., constructed in accordance with the match 704 shown in FIG. 7A and discussed above) associated with the tournament shown in the tournament administration view 900.

The tournament administration view 900 may further include the tournament rules pane 908. The tournament rules pane 908 may display one or more field having values corresponding to one or more tournament property. As shown in FIG. 9A, the tournament rules pane 908 may include a first field 924a showing a default match profit target, a second field 924b showing the default match starting balance, a third field 924c showing the default match risk limit percent, a fourth field 924d showing the default match max drawdown percent, and a fifth field 924e showing the default match daily drawdown percent. The tournament rules pane 908 may further include an expand input 928 (shown, for example, as a “Read all” button) that, when selected, will cause the client processor 58 to show additional tournament properties, and may show all tournament properties the tournament administrator, or other user that selects the expand input 928 has permissions to see.

Referring now to FIGS. 9B-9C, in combination, shown therein is an illustration of an exemplary embodiment of the user device 18 displaying the primary user interface 30 with a new match modal 940 constructed in accordance with the present disclosure. The new match modal 940 may be provided to the user 14 or tournament administrator to receive one or more new match property for a newly created match as part of the tournament. In some embodiments, the one or more new match properties may include the one or more default new match properties as values presented to the tournament administrator. The new match modal 940 may be provided as a multi-step form having a first new match form 944a shown in FIG. 9B and a second new match form 944b shown in FIG. 9C. While the new match modal 940 is described as a modal, in other embodiments, the new match modal 940 is not limited to being a modal, and may be, for example, any type of UI/UX element as described above and/or the like, or a combination thereof.

The first new match form 944a shown in FIG. 9B may include one or more input corresponding to the one or more new match property such as a final match indicator 946 operable to receive an input of whether the particular new match is the final match of the tournament, a match name input 948 operable to receive an input corresponding to the match name, a starting balance input 950 operable to receive an input for a match starting balance that all participants (e.g., users 14 participating in the match) start with, a match duration input 952 operable to receive an input for a match duration (in “real world” time, i.e., actual time, not simulation time), a max participants input 954 operable to receive an input for a number of maximum participants, and an assets list input 955 operable to receive one or more input for a match session pair list. Each of the one or more inputs may be provided with corresponding default values from the tournament properties, however, the tournament administrator may change individual values for a particular match prior to creating the particular match.

The second new match form 944b shown in FIG. 9C may include one or more input corresponding to the one or more new match property such as a match profit target input 956 operable to receive an input of a match profit target percent, a max drawdown input 958 operable to receive an input corresponding to a match drawdown percent, a daily drawdown input 960 operable to receive an input for a match daily drawdown percent, and a max risk input 962 operable to receive an input for a match max risk per trade percent. In one embodiment, the match profit target percent, when filled out, will cause the match to end when any participant in the match hits the profit target percent in the participant's backtesting session regardless of the match duration. The max drawdown percent, when filled out, will cause the match to end for the participant when the max drawdown percent is reached in the participant's backtesting session. The max daily drawdown percent is a maximum a participant may lose in one trading day in the participant's backtesting session. The max risk per trade percent is a maximum amount a participant can risk per trade in the participant's backtesting session.

It should be understood that while the one or more inputs corresponding to the one or more new match property are shown across multiple forms 944, in some embodiments, all of the one or more inputs may be provided on a single modal or form, fewer modals or forms, or additional modals or forms. In some embodiments, the new match modal 940 may include additional inputs corresponding to the one or more new match property or fewer inputs corresponding to the one or more new match property. For example, the new match modal 940 may exclude one or more of the new match inputs from the new match modal 940 and instead provide predetermined values for the excluded one or more new match properties.

In one embodiment, upon selection of a create input 964 by the user 14, e.g., via the input device 50, the client processor 58 may transmit each input of the multiple forms 944 of the new match modal 940 to the service processor 86 to create the new match having match properties corresponding to values of the one or more inputs of the new match modal 940 and may add the user 14, that selected the create input 964, as a match administrator for the newly created match. In some embodiments, the tournament administrator of a particular tournament is a match administrator for each hosted match for the particular tournament.

In one embodiment, upon creation of the new match, the client processor 58 may cause the user device 18 to display the tournament administration view 900 such that the tournament administration view 900 is displayed in the primary user interface 30 of the output device 54.

Referring now to FIG. 9D, shown therein is an illustration of an exemplary embodiment of the tournament administration view 900 including the new match drawn in accordance with the present disclosure. The match list 904 may then show the new match within the match list 904 as the hosted match 980. In some embodiments, the match list 904 may display a plurality of hosted matches 980 however only one hosted match 980 is shown for simplicity. The hosted match 980 may be shown, for example, in a hosted match card 982 having fields corresponding to the one or more match property.

In one embodiment, the tournament administrator may control the hosted match 980 via the match controller 912. Referring now to FIGS. 9E-9F, in combination, shown therein are illustrations of exemplary embodiments of the match controller 912 in a first state (in FIG. 9E) and in a second state (in FIG. 9F) operable to control an active match. The match controller 912 may be provided with an expansion control 986, that upon selection by the user 14, causes the client processor 58 to toggle the match controller 912 between the first state and the second state. The match controller 912 may further include a positioning control 988 operable to receive an input from the user 14 and allow the user 14 to place the match controller 912 at a plurality of locations in the primary user interface 30. The match controller 912 may further include a time display 990 operable to show a time remaining for the active match. In one embodiment, the active match may be a particular hosted match 980 in the match list 904 that is selected by the user 14. For example, if there are multiple hosted matches occurring simultaneously, the user 14 may select the hosted match card 982 corresponding to a particular hosted match to cause the selected hosted match to be the active match controllable by the match controller 912. In some embodiments, when there is only one hosted match 980 that has time remaining, the match controller 912 may default to controlling that one hosted match 980, e.g., the only hosted match 980 may be the active match.

The match controller 912 while in the second state (shown in FIG. 9F), may further be provided with a start input 992, a pause input 994, and an end match input 996. In one embodiment, upon selection of the start input 992, the client processor 58 may transmit a start signal to the service processor 86 to cause the service processor 86 to begin the match. The service processor 86 may begin the match by sending a begin signal to respective client processors 58 of respective user devices 18 of each participant. When the match begins, the time display 990 may show a timer with the remaining time of the match. In one embodiment, upon receiving an indication of the tournament administrator selecting the end match input 996, e.g., by receiving an end match signal, the service processor 86 may terminate/end the active match for each participant, as detailed below.

Referring now to FIG. 10, shown therein is an illustration of an exemplary embodiment of the user device 18 displaying the primary user interface 30 with the tournament administration view 900 showing the global leaderboard 1000 as constructed in accordance with the present disclosure. The global leaderboard 1000 may show a ranking of participants of each hosted match within the tournament. The ranking of participants may be calculated based on one or more metric, such as a realized profit when a profit target is provided, otherwise the ranking may be calculated based on unrealized profit when the match duration has ended (e.g., the time of the match has expired).

It should be understood that each participant in each match may have separate backtesting sessions provided with the match properties, e.g., the session pairs match property is used to provide session pairs to the backtesting session of each participant. For example, the participant may select one or more session pair when joining a match, however, the service processor 86 may select a particular one of the session pairs for the user's backtesting session as part of the match such that the participant is not able to decide which specific session pair the participant will trade with. Additionally, the service processor 86 may select the simulation time and/or simulation timeframe of the backtesting session for each participant. Each participant may have the same simulation duration, however, e.g., the simulation duration may be 12 months, but the participant does not know the historic date/time of the historic market instrument the participant is trading with. In this way, backtesting session for the participant is provided with “randomness” even though an actual historic market instrument is being traded against in the backtesting session.

Referring now to FIGS. 11A-11B in combination, shown therein is a flow diagram of an exemplary embodiment of a challenge process 1100 constructed in accordance with the present disclosure. The challenge process 1100 may be executed by the service processor 86 and/or the client processor 58 in response to inputs from the user 14 via the user device 18. The challenge process 1100 provides a technical solution for efficiently creating and managing multi-participant trading competitions within the backtesting system 10. After the user 14 has selected the challenges option 703 from the navigation bar 702, the client processor 58 may await further input from the user 14 (in step 1102).

In one embodiment, at step 1104 the service processor 86 receives a request to create a new tournament, e.g., via selection of the new tournament input 710. The request may be received from the client processor 58 of the user device 18, such as from the tournament administrator via the primary user interface 30. For example, the tournament administrator may select the new tournament input 710 on the match dashboard 700, as previously described in relation to FIG. 7A.

Following the creation of the new tournament, the service processor 86 proceeds to step 1116 to determine whether the user 14 having provided the request to create the new tournament is a paid user (step 1128) or a free user (step 1130). If the user 14 is a free user, the service processor 86 may cause the client processor 58 to display an indication that the free user cannot create a tournament (step 1132). If the user is a paid user, then the user 14 may either access a match with a challenge ID (step 1142) or create a new challenge (step 1140) via the create challenge flow 1200 (shown at step 1146 and illustrated in FIGS. 12A-12B).

When accessing challenges with the challenge ID (step 1142) the client processor 58 may transmit the challenge id (step 1148) to the service processor 86 for the service processor 86 to validate the challenge ID (step 1156) and, if the challenge ID is correct, may determine whether the challenge is active (step 1168). If the challenge is active in step 1168, the service processor 86 may determine if the participant limit has been met (e.g., of the participant queue 716h) (step 1170) and, if the user limit has been met, may cause the client processor 58 to display a modal to the user 14 via the primary user interface 30 that the user limit for the respective challenge has been met/that the match is full (step 1176), however, if the user limit has not been met, the service processor 86 may cause the client processor 58 to display a match lobby to the user 14 (step 1172). If the challenge ID is incorrect in step 1156, the service processor 86 may cause the client processor 58 to show one or more error messages to the user 14 via the primary user interface 30 (step 1158). If the challenge is inactive in step 1168, the service processor 86 may cause the client processor 58 to display a modal to the user 14 via the primary user interface 30 that the challenge is not available (step 1166).

When the user 14 is in the match dashboard 700, the client processor 58 may determine whether there are any active challenges (step 1108) and if so (at step 1118) may show the active challenge on the match dashboard 700 of the primary user interface 30 (step 1136). If there are no active challenges (step 1106) then the client processor 58 may create a new challenge from active challenges (step 1134) and proceed to step 1140. For each of the active matches 704 shown in the match dashboard 700, the client processor 58 may receive updates for each of the active matches 704 from the service processor 86. When the challenge ends (step 1152) the client processor 58 may display a modal on the primary user interface 30 indicating that the challenge will be permanently deleted (step 1162). When the user 14 selects an active match 704 (step 1150), the client processor 58 may transmit the request to the service processor 86 to determine if the challenge is already started (step 1160) and if the challenge is not started, may cause the client processor 58 to display a match lobby to the user 14 (step 1172), but if the challenge is already started, may continue to step 1174 where the service processor 86 cause the client processor 58 to receive a backtesting session associated with the challenge and display the backtesting session view 300 (shown in FIG. 4).

In one embodiment, the client processor 58 may show a challenge profile 705 in the match dashboard 700 corresponding to the user 14 (in step 1110) and show any trophies (step 1122) or allow the user 14 to edit the profile via an edit input 707 (step 1120).

At step 1112 the user 14 may view match history where, if empty (step 1126), the user 14 may join a match with a match ID (step 1124). When the match history is not empty in step 1126, the client processor 58 may determine whether the challenge is completed (step 1138), may show challenges (step 1144), see states (step 1154), and then show complete challenge states modal on the primary user interface 30 (step 1164).

At step 1114, the service processor 86 may show a global leaderboard (shown in FIG. 10, for example) upon selection of a global leaderboard tab 709e in FIG. 7A.

The challenge process 1100 thus provides an efficient technical solution for creating and managing multi-participant trading competitions within the backtesting system 10. By enabling tournament administrators to create structured tournaments with standardized match properties, and by providing mechanisms for participant matching, session pair assignment, and performance tracking, the challenge process 1100 enhances the collaborative and competitive aspects of the backtesting system 10.

Referring now to FIGS. 12A-12B in combination, shown therein is a flow chart of an exemplary embodiment of a create challenge flow 1200 constructed in accordance with the present disclosure. The create challenge flow 1200 may start when the user 14 selects to create a challenge (step 1202) such as by selection of a start match input 922 of FIG. 9A. The tournament administrator may then be presented with the first new match form 944a to provide match settings/properties (step 1204) then the second new match form 944b to provide optional match settings/properties (step 1206). Once the match is created at step 1208 (e.g., upon selection of the input 964) the tournament administrator is directed to the tournament administration view 900 by the client processor 58 (step 1212) at which point the client processor 58 may display the tournament rules pane 908 (step 1214) which may allow the tournament administrator to close the tournament rules pane 908 (step 1216). If the user selects a cancel button 966, then creation of the new match may be cancelled (step 1210).

When the client processor 58 displays the tournament administration view 900 the match controller 912 may be shown (step 1218) and the tournament administrator may be provided with controls such as participant controls (step 1220) which may allow the tournament administrator to expel a particular participant (step 1228), display a confirmation modal (step 1234), and expel the participant to cause the primary user interface 30 of the participants particular user devices 18 to return to the match dashboard 700 and may further show a modal to the participant indicating the same; a start challenge control, e.g., start input 992, at step 1222 which when selected by the tournament administrator (at step 1230) to start the match, an end match control, e.g., end match input 996, at step 1224 which may allow the tournament administrator to end the match and expel all participants in the match to the match dashboard 700 at step 1238; and a rules control (step 1226) which may allow the tournament administrator to update or modify the rules for a particular hosted match or the tournament as a whole.

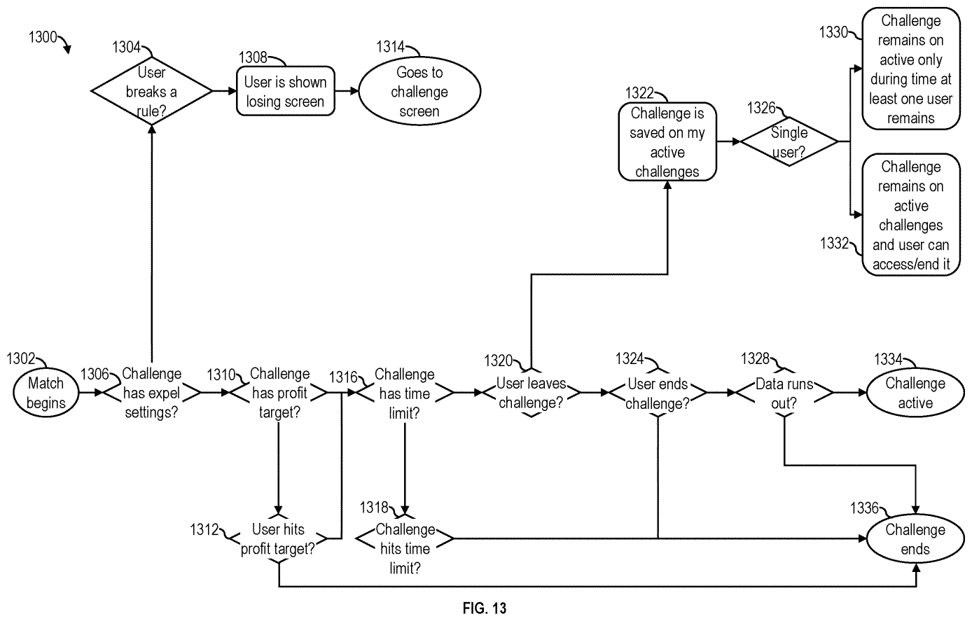

In one embodiment, after the tournament administrator starts the match at step 1230, a match process 1300 (shown in FIG. 13, below) begins (step 1236). Once the match ends (either by expiration of time or termination by the tournament administrator) the client processor 58 of each participants'user devices 18 may display a “time's up” modal (step 1242) and if the user won (step 1244) shows a first place screen stats (step 1246) or otherwise shows a game over screen stats (step 1248). Upon selection to see results, the client processor 58 of respective participants may show a podium screen 1250 similar to the global leaderboard 1000 then cause the primary user interface 30 to return to the match dashboard 700 (step 1252).

Referring now to FIG. 13, shown therein is a process flow diagram of an exemplary embodiment of the match process 1300 constructed in accordance with the present disclosure. After the match begins (step 1302), if the match has expel settings (step 1306) and a user breaks a rule, e.g., the one or more active rules 830 (step 1304), then the user 14 is shown the losing screen (step 1308) and is sent to the match dashboard 700 (step 1314). During the match, the service processor 86 may monitor progress of each participant and determine whether any participant has met the profit target (step 1310), and if a particular participant has met the profit target (step 1312) then the match ends (step 1336). During the match, the service processor 86 may monitor progress of each participant and determine whether the match time limit is set (step 1316) and if the match time limit has been met (at step 1318) then the match ends (step 1336).

During the match, the service processor 86 may monitor progress of each participant and determine whether a participant leaves the match (step 1320) in which case the match is saved in the participant's “active challenges” (step 1322), e.g., by associating the participant user ID with the match ID in the service memory 82 or the client memory 66, for example. If there is only a single user in the match (step 1326) and the time has not expired, the challenge remains active for users to reenter (step 1330); otherwise the user can access/end it (step 1332). That is, if all participants leave a match, then the match will no longer be active and will go to the challenge end step (optionally, even when the time has not yet expired).

At step 1324, if the tournament administrator ends the challenge, then the service processor 86 may mark the match as “ended” and stop the backtesting session for each user participant associated with the match ID. The service processor 86 may transmit a match end signal to the user devices 18 of each participant (e.g., via step 1242). At step 1328, if the historic market instrument (e.g., corresponding to the session pairs of the match) has no more data within the simulation timeframe of the match, then the challenge may end (step 1336), otherwise the match may continue with an active status (step 1334).

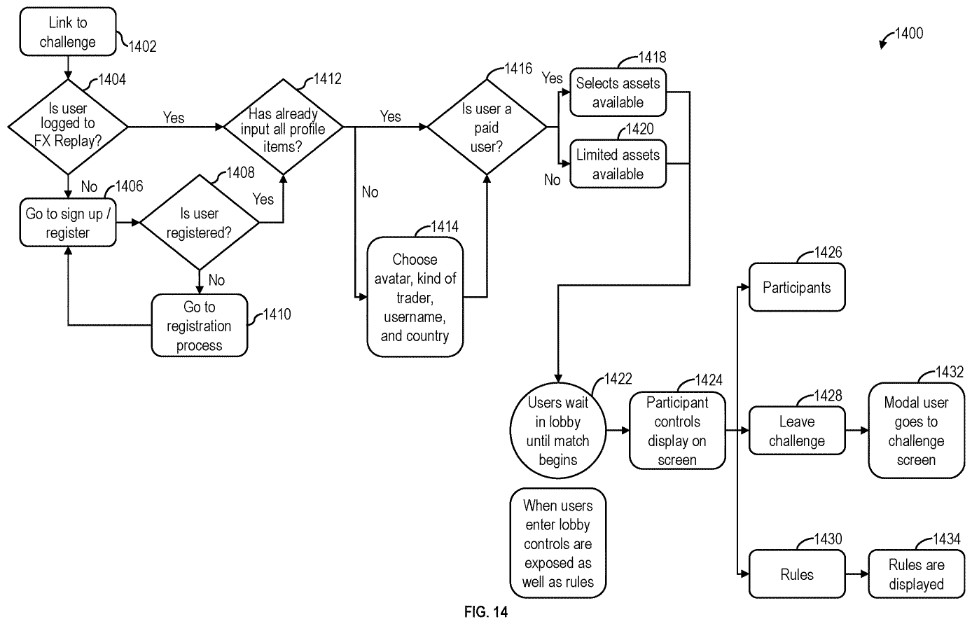

Referring now to FIG. 14, shown therein is a process flow diagram of an exemplary embodiment of a challenge creation process 1400 constructed in accordance with the present disclosure. In step 1402, when a potential participant receives and then goes to a link, e.g., as provided by the invite input 920, the service processor 86 may determine whether the potential participant is logged into the backtesting system 10 (step 1404). If the potential participant is not logged in, the potential participant may be directed to signup or register (step 1406) and if the potential participant is not registered (step 1408) then the potential participant is directed to a registration screen (step 1410). If the potential participant is registered, e.g., has a user account, at step 1408, the service processor 86 may determine whether the potential participant has a challenge profile 705 (shown in FIG. 7A) at step 1412, which if the potential participant has the challenge profile, continues to step 1416, but if the potential participant does not have the challenge profile 705, the client processor 58 provides a form to the potential participant to fill out profile information (step 1414) and continues to step 1416.

At step 1416, the service processor 86 (optionally) determines whether the potential participant is a paid user (step 1416) to determine whether to provide the potential participant with a limited set of assets (e.g., session pairs) to choose from (step 1420) or to provide the potential participant with a larger set of assets to choose from (step 1418). The potential participant may then join the match lobby as a participant (step 1422). When the participant enters the match lobby, controls are exposed to the participant (step 1424) as well as match rules (step 1434) when the rules are present (step 1430). In some embodiments, the participant may see other participants in the match (step 1426). The participant may also be given an option to leave the match (step 1428) and if the participant selects to leave the match, the service processor 86 removes the participant from the match and causes the client processor 58 of the now-former participant to display the match dashboard 700 on the primary user interface 30 of the user devices 18 (step 1432).

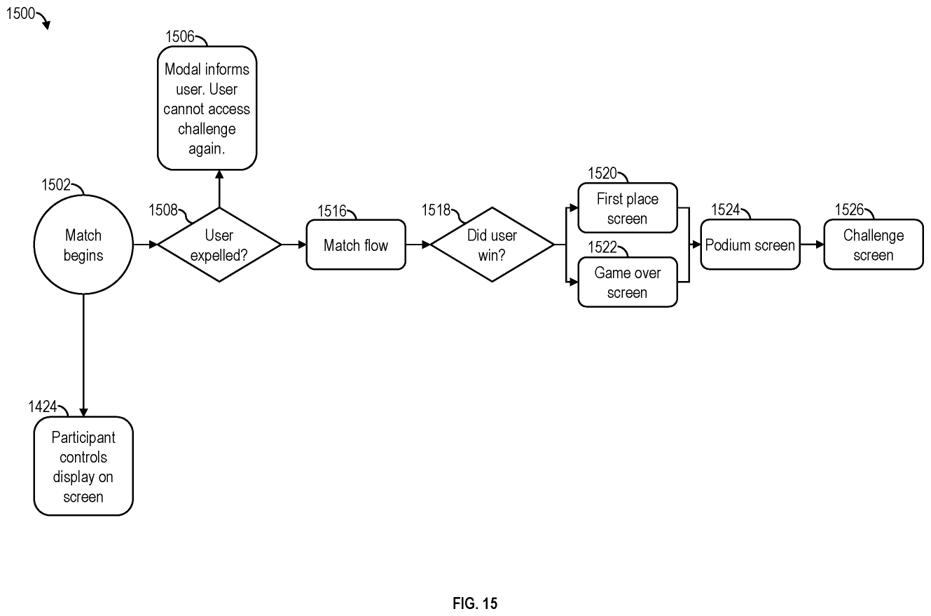

Referring now to FIG. 15, shown therein is a process flow diagram of an exemplary embodiment of a participant flow 1500 constructed in accordance with the present disclosure. When the participant flow 1500 begins at step 1502, the client processor 58 or the service processor 86 displays participant controls on the primary user interface 30 of each user device 18 of the participants (e.g., step 1424, shown in FIG. 14 and detailed above). Displaying the participant controls (e.g., step 1424) may include displaying the leaderboard (shown in FIG. 10), displaying other participants (as described above in step 1426), or providing the participant the option to leave (as described above in step 1428).

At step 1508, if the tournament administrator expels a user from a match, the service processor 86 causes the client processor 58 of the expelled user to display a modal on the primary user interface 30 indicating that the expelled user is not able to access the challenge again (step 1506).

At step 1516 the match process 1300 is executing. In some embodiments, when a participant profits or loses money, the service processor 86 may cause that user's user devices 18 to output a notification via the output device 54 such as by outputting an animation on the primary user interface 30 or a sound via the output device 54. When the match ends, the service processor 86 determines whether the particular user won (step 1518) and if the user came in first place is shown a first place screen (step 1520), and otherwise is shown a game over screen (step 1522). After the client processor 58 shows the user placement screen, the client processor 58 displays the podium screen on the primary user interface 30 (step 1524). Upon exiting the podium screen, the client processor 58 displays the match dashboard 700 on the primary user interface 30 (step 1526). In this way, after the user 14 is shown the results of the match, the user 14 may select another match to enter and compete in.

### Illustrative Clauses

The following are illustrative clauses demonstrating non-limiting implementations of the present disclosure:

Clause 1. A backtesting system, comprising: a service device, comprising: a service processor; and a service memory comprising a non-transitory processor-readable medium storing processor-executable instructions that when executed by the service processor, causes the service processor to: receive a request to create a match having match properties from an administrator device of a tournament administrator, the match properties comprising at least a match name, a match time limit, a max participants value, a match starting balance, and a session pair list; store the match properties in the service memory; receive a first join match signal from a first user device of a first potential participant having a first user ID; associate the first user ID with a match ID of the match such that the first potential participant is a first participant; receive a second join match signal from a second user device of a second potential participant having a second user ID; associate the second user ID with the match ID such that the second potential participant is a second participant; receive a start match signal from the administrator device of the tournament administrator; generate a first backtesting session for the first participant based on the match properties and a second backtesting session for the second participant based on the match properties; simultaneously manage execution of and track performance metrics for the first backtesting session and the second backtesting session; determine whether any match termination criteria have been met, the match termination criteria comprising at least expiration of the match time limit; upon determining at least one match termination criteria has been met, terminate the first backtesting session and the second backtesting session simultaneously; determine a match winner between the first participant and the second participant based on at least one performance metric; and transmit a match end signal to the first user device and the second user device to cause the first user device and the second user device to display a match end modal indicating the match winner.

Clause 2. The backtesting system of Clause 1, wherein the processor-executable instructions, when executed by the service processor, further cause the service processor to: validate whether the first potential participant meets participant criteria for the match prior to associating the first user ID with the match ID; and validate whether the second potential participant meets participant criteria for the match prior to associating the second user ID with the match ID.

Clause 3. The backtesting system of any of clauses 1 to 2, wherein generating the first backtesting session comprises: selecting a first session pair for the first participant from the session pair list; selecting a first simulation timeframe for the first participant; and setting a first starting balance for the first participant based on the match properties; and wherein generating the second backtesting session comprises: selecting a second session pair for the second participant from the session pair list; selecting a second simulation timeframe for the second participant; and setting a second starting balance for the second participant based on the match properties.

Clause 4. The backtesting system of any of clauses 1 to 3, wherein the match properties further comprise a profit target and a maximum drawdown, and wherein the match termination criteria further comprise at least one of: achievement of the profit target and exceeding the maximum drawdown.

Clause 5. The backtesting system of clause 4, wherein: the profit target comprises a predetermined percentage gain on the match starting balance; and the maximum drawdown comprises a predetermined percentage loss from a peak account balance.

Clause 6. The backtesting system of any of clauses 1 to 5, wherein simultaneously managing execution of the first backtesting session and the second backtesting session comprises: maintaining the first backtesting session with a first simulation time for the first participant; maintaining the second backtesting session with a second simulation time for the second participant, the second simulation time being different from the first simulation time; providing first delta-encoded price data to the first user device based on the first simulation time; and providing second delta-encoded price data to the second user device based on the second simulation time.

Clause 7. The backtesting system of any of clauses 1 to 6, wherein the processor-executable instructions that cause the service processor to generate the first backtesting session further comprise: causing the first user device to display a first backtesting session view, and wherein the processor-executable instructions that cause the service processor to generate the second backtesting session further comprise: causing the second user device to display a second backtesting session view different from the first backtesting session view.

Clause 8. The backtesting system of any of clauses 1 to 7, wherein the processor-executable instructions, when executed by the service processor, further cause the service processor to: receive, from the administrator device of the tournament administrator, a request to create a tournament having tournament properties prior to receiving the request to create the match, the tournament properties including at least a tournament ID, a tournament name, a tournament rules list, and a default session pair list; store the tournament properties in the service memory; and wherein the instructions to store the match properties further include instructions to associate the match ID with the tournament ID.

Clause 9. The backtesting system of clause 8, wherein the session pair list is the default session pair list and wherein the tournament properties further include a default profit target and a default maximum drawdown.

Clause 10. The backtesting system of any of clauses 1 to 9, wherein the match termination criteria further comprise receiving an end match signal from the administrator device of the tournament administrator.

Clause 11. A method for providing a backtesting tournament, the method comprising: receiving, by a service device, a request to create a match having match properties from an administrator device of a tournament administrator; storing, by the service device, the match properties in a service memory, the match properties comprising at least a match name, a match time limit, a max participants value, a match starting balance, and a session pair list; receiving, by the service device, a first join match signal from a first user device of a first potential participant having a first user ID; associating, by the service device, the first user ID with a match ID of the match such that the first potential participant is a first participant; receiving, by the service device, a second join match signal from a second user device of a second potential participant having a second user ID; associating, by the service device, the second user ID with the match ID such that the second potential participant is a second participant; receiving, by the service device, a start match signal from an administrator device of the tournament administrator; generating, by the service device, a first backtesting session for the first participant based on the match properties and a second backtesting session for the second participant based on the match properties; simultaneously managing, by the service device, execution of and tracking performance metrics for the first backtesting session and the second backtesting session; determining, by the service device, whether any match termination criteria have been met, the match termination criteria comprising at least expiration of the match time limit; upon determining at least one match termination criteria has been met, terminating, by the service device, the first backtesting session and the second backtesting session simultaneously; determining, by the service device, a match winner between the first participant and the second participant based on at least one performance metric; and transmitting, by the service device, a match end signal to the first user device and the second user device to cause the first user device and the second user device to display a match end modal indicating the match winner.

Clause 12. The method of clause 11, further comprising: validating, by the service device, whether the first potential participant meets participant criteria for the match prior to associating the first user ID with the match ID; and validating, by the service device, whether the second potential participant meets participant criteria for the match prior to associating the second user ID with the match ID.

Clause 13. The method of any of clauses 11 to 12, wherein generating the first backtesting session comprises: selecting a first session pair for the first participant from the session pair list; selecting a first simulation timeframe for the first participant; and setting a first starting balance for the first participant based on the match properties; and wherein generating the second backtesting session comprises: selecting a second session pair for the second participant from the session pair list; selecting a second simulation timeframe for the second participant; and setting a second starting balance for the second participant based on the match properties.

Clause 14. The method of any of clauses 11 to 13, wherein the match properties further comprise a profit target and a maximum drawdown, and wherein the match termination criteria further comprise at least one of: achievement of the profit target and exceeding the maximum drawdown.

Clause 15. The method of clause 14, wherein: the profit target comprises a predetermined percentage gain on the match starting balance; and the maximum drawdown comprises a predetermined percentage loss from a peak account balance.

Clause 16. The method of any of clauses 11 to 15, wherein simultaneously managing execution of the first backtesting session and the second backtesting session comprises: maintaining the first backtesting session with a first simulation time for the first participant; maintaining the second backtesting session with a second simulation time for the second participant, the second simulation time being different from the first simulation time; providing first delta-encoded price data to the first user device based on the first simulation time; and providing second delta-encoded price data to the second user device based on the second simulation time.

Clause 17. The method of any of clauses 11 to 16, wherein generating the first backtesting session for the first participant further comprises causing the first user device to display a first backtesting session view, and wherein generating the second backtesting session for the second participant further comprises causing the second user device to display a second backtesting session view different from the first backtesting session view.

Clause 18. The method of any of clauses 11 to 17, further comprising: receiving, from the administrator device of the tournament administrator, a request to create a tournament having tournament properties prior to receiving the request to create the match, the tournament properties including at least a tournament ID, a tournament name, a tournament rules list, and a default session pair list; storing the tournament properties in the service memory; and wherein storing the match properties further includes associating the match ID with the tournament ID.

Clause 19. The method of clause 18, wherein the session pair list is the default session pair list and wherein the tournament properties received further include a default profit target and a default maximum drawdown.

Clause 20. The method of any of clauses 11 to 19, wherein the match termination criteria further comprise receiving an end match signal from the administrator device of the tournament administrator.

### Conclusion

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred implementation. Further, the phrase “based on” is intended to mean “based, at least in part, on” unless explicitly stated otherwise.

What is claimed is:

1. A backtesting system, comprising:
a service device, comprising:
a service processor; and
a service memory comprising a non-transitory processor-readable medium storing
processor-executable instructions that when executed by the service processor, causes the service processor to:
receive a request to create a match having match properties from an administrator device of a tournament administrator, the match properties comprising at least a match name, a match time limit, a max participants value, a match starting balance, and a session pair list;
store the match properties in the service memory;
receive a first join match signal from a first user device of a first potential participant having a first user ID;
associate the first user ID with a match ID of the match such that the first potential participant is a first participant;
receive a second join match signal from a second user device of a second potential participant having a second user ID;
associate the second user ID with the match ID such that the second potential participant is a second participant;
receive a start match signal from the administrator device of the tournament administrator;
generate a first backtesting session for the first participant based on the match properties and a second backtesting session for the second participant based on the match properties;
simultaneously manage execution of and track performance metrics for the first backtesting session and the second backtesting session;
determine whether any match termination criteria have been met, the match termination criteria comprising at least expiration of the match time limit;
upon determining at least one match termination criteria has been met, terminate the first backtesting session and the second backtesting session simultaneously;
determine a match winner between the first participant and the second participant based on at least one performance metric; and
transmit a match end signal to the first user device and the second user device to cause the first user device and the second user device to display a match end modal indicating the match winner.

2. The backtesting system of claim 1, wherein the processor-executable instructions, when executed by the service processor, further cause the service processor to:
validate whether the first potential participant meets participant criteria for the match prior to associating the first user ID with the match ID; and
validate whether the second potential participant meets participant criteria for the match prior to associating the second user ID with the match ID.

3. The backtesting system of claim 1, wherein generating the first backtesting session comprises:
selecting a first session pair for the first participant from the session pair list;
selecting a first simulation timeframe for the first participant; and
setting a first starting balance for the first participant based on the match properties; and
wherein generating the second backtesting session comprises:
selecting a second session pair for the second participant from the session pair list;
selecting a second simulation timeframe for the second participant; and
setting a second starting balance for the second participant based on the match properties.

4. The backtesting system of claim 1, wherein the match properties further comprise a profit target and a maximum drawdown, and wherein the match termination criteria further comprise at least one of: achievement of the profit target and exceeding the maximum drawdown.

5. The backtesting system of claim 4, wherein:
the profit target comprises a predetermined percentage gain on the match starting balance; and
the maximum drawdown comprises a predetermined percentage loss from a peak account balance.

6. The backtesting system of claim 1, wherein simultaneously managing execution of the first backtesting session and the second backtesting session comprises:
maintaining the first backtesting session with a first simulation time for the first participant;
maintaining the second backtesting session with a second simulation time for the second participant, the second simulation time being different from the first simulation time;
providing first delta-encoded price data to the first user device based on the first simulation time; and
providing second delta-encoded price data to the second user device based on the second simulation time.

7. The backtesting system of claim 1, wherein the processor-executable instructions that cause the service processor to generate the first backtesting session further comprise:
causing the first user device to display a first backtesting session view, and
wherein the processor-executable instructions that cause the service processor to generate the second backtesting session further comprise:
causing the second user device to display a second backtesting session view different from the first backtesting session view.

8. The backtesting system of claim 1, wherein the processor-executable instructions, when executed by the service processor, further cause the service processor to:
receive, from the administrator device of the tournament administrator, a request to create a tournament having tournament properties prior to receiving the request to create the match, the tournament properties including at least a tournament ID, a tournament name, a tournament rules list, and a default session pair list;
store the tournament properties in the service memory; and
wherein the processor-executable instructions to store the match properties further include processor-executable instructions to associate the match ID with the tournament ID.

9. The backtesting system of claim 8, wherein the session pair list is the default session pair list and wherein the tournament properties further include a default profit target and a default maximum drawdown.

10. The backtesting system of claim 1, wherein the match termination criteria further comprise receiving an end match signal from the administrator device of the tournament administrator.

11. A method for providing a backtesting tournament, the method comprising:
receiving, by a service device, a request to create a match having match properties from an administrator device of a tournament administrator;
storing, by the service device, the match properties in a service memory, the match properties comprising at least a match name, a match time limit, a max participants value, a match starting balance, and a session pair list;
receiving, by the service device, a first join match signal from a first user device of a first potential participant having a first user ID;
associating, by the service device, the first user ID with a match ID of the match such that the first potential participant is a first participant;
receiving, by the service device, a second join match signal from a second user device of a second potential participant having a second user ID;
associating, by the service device, the second user ID with the match ID such that the second potential participant is a second participant;
receiving, by the service device, a start match signal from an administrator device of the tournament administrator;
generating, by the service device, a first backtesting session for the first participant based on the match properties and a second backtesting session for the second participant based on the match properties;
simultaneously managing, by the service device, execution of and tracking performance metrics for the first backtesting session and the second backtesting session;
determining, by the service device, whether any match termination criteria have been met, the match termination criteria comprising at least expiration of the match time limit;
upon determining at least one match termination criteria has been met, terminating, by the service device, the first backtesting session and the second backtesting session simultaneously;
determining, by the service device, a match winner between the first participant and the second participant based on at least one performance metric; and
transmitting, by the service device, a match end signal to the first user device and the second user device to cause the first user device and the second user device to display a match end modal indicating the match winner.

12. The method of claim 11, further comprising:
validating, by the service device, whether the first potential participant meets participant criteria for the match prior to associating the first user ID with the match ID; and
validating, by the service device, whether the second potential participant meets participant criteria for the match prior to associating the second user ID with the match ID.

13. The method of claim 11, wherein generating the first backtesting session comprises:
selecting a first session pair for the first participant from the session pair list;
selecting a first simulation timeframe for the first participant; and
setting a first starting balance for the first participant based on the match properties; and wherein generating the second backtesting session comprises:
selecting a second session pair for the second participant from the session pair list;
selecting a second simulation timeframe for the second participant; and
setting a second starting balance for the second participant based on the match properties.

14. The method of claim 11, wherein the match properties further comprise a profit target and a maximum drawdown, and wherein the match termination criteria further comprise at least one of: achievement of the profit target and exceeding the maximum drawdown.

15. The method of claim 14, wherein:
the profit target comprises a predetermined percentage gain on the match starting balance; and
the maximum drawdown comprises a predetermined percentage loss from a peak account balance.

16. The method of claim 11, wherein simultaneously managing execution of the first backtesting session and the second backtesting session comprises:
maintaining the first backtesting session with a first simulation time for the first participant;
maintaining the second backtesting session with a second simulation time for the second participant, the second simulation time being different from the first simulation time;
providing first delta-encoded price data to the first user device based on the first simulation time; and
providing second delta-encoded price data to the second user device based on the second simulation time.

17. The method of claim 11, wherein generating the first backtesting session for the first participant further comprises causing the first user device to display a first backtesting session view, and wherein generating the second backtesting session for the second participant further comprises causing the second user device to display a second backtesting session view different from the first backtesting session view.

18. The method of claim 11, further comprising:
receiving, from the administrator device of the tournament administrator, a request to create a tournament having tournament properties prior to receiving the request to create the match, the tournament properties including at least a tournament ID, a tournament name, a tournament rules list, and a default session pair list;
storing the tournament properties in the service memory; and
wherein storing the match properties further includes associating the match ID with the tournament ID.

19. The method of claim 18, wherein the session pair list is the default session pair list and wherein the tournament properties received further include a default profit target and a default maximum drawdown.

20. The method of claim 11, wherein the match termination criteria further comprise receiving an end match signal from the administrator device of the tournament administrator.
